(19) United States
(12) Patent Application Publication
(10) Pub. No.: US 2014/0099249 A1
(43) Pub. Date: Apr. 10, 2014

(54) IONIC LIQUIDS BASED ON OXALIC ACID MONO ESTERS

(71) Applicant: BASF SE, Ludwigshafen (DE)

(72) Inventors: Klemens Massonne, Bad Durkheim (DE); Joerg Sundermeyer, Marburg (DE); Axel Braam, Marburg (DE)

(73) Assignee: BASF SE, Ludwigshafen (DE)

(21) Appl. No.: 14/049,371

(22) Filed: Oct. 9, 2013

Related U.S. Application Data
(60) Provisional application No. 61/711,762, filed on Oct. 10, 2012.

(51) Int. Cl. C01F 17/00; B01F 1/00

(52) U.S. Cl. CPC C01F 17/0068; B01F 1/0005
USPC 423/263; 562/597; 548/335.1; 546/304; 548/579

(57) ABSTRACT

Monosubstituted oxalic acid derivatives of the general formula (I)

[A]⁺[O—C(O)—C(O)—O—X⁻ (I)

Wherein the meaning is for
[A]⁺ a cation made from an organic moiety A having a formally positively charged heteroatom selected from the group consisting of nitrogen, phosphorus and sulfur
X is a C1 to C30 organic residue
   and wherein the following compounds (I) are disclaimed:
Tetramethylammonium monomethyloxalate
Methyltri(alkyl)ammonium monomethyloxalate
Trimethyl(1-hydroxyethyl)ammonium monomethyloxalate
Methyltriethylammonium monomethyloxalate
Tetraethylammonium monomethyloxalate
n-Propyltriethylammonium mono-n-propyloxalate
n-Butyltriethylammonium mono-n-butyloxalate
Benzyltriethylammonium monobenzyloxalate
cyclohexyldimethylammonium monomethyloxalate
Dimethyl-phenylammonium monomethyloxalate.
Tetrabutylammonium monomethyloxalate
N-methylpyridinium monomethyloxalate
N-ethylpyridinium monoethyloxalate
N-n-propylpyridinium mono-n-propyloxalate
N-n-butylpyridinium mono-n-butyloxalate
N-benzylpyridinium monobenzyloxalate
N-methyl-isochinolinium monomethyloxalate
N-ethyl-isochinolinium monoethyloxalate
N-n-propyl-isochinolinium mono-n-propyloxalate
N-n-butyl-isochinolinium mono-n-butyloxalate
N-benzyl-isochinolinium monobenzyloxalate.

### CROSS-REFERENCE TO RELATED APPLICATIONS

This application claims the benefit of U.S. Provisional Application 61/711,762, filed Oct. 10, 2012, which is incorporated herein by reference.

The present invention relates to monosubstituted oxalic acid derivatives of the general formula (I)

[A]⁺[O—C(O)—C(O)—O—X]⁻ (I)

wherein the meaning is for

[A]⁺ a cation made from an organic moiety A having a formally positively charged heteroatom selected from the group consisting of nitrogen, phosphorus and sulfur,

X is a C₁ to C₃₀ organic residue

and wherein the following compounds (I) are disclaimed to the extent they relate to the composition of matter claims:

Tetramethylammonium monomethyloxalate

Methyltri(alkyl)ammonium monomethyloxalate

Trimethyl(1-hydroxyethyl)ammonium monomethyloxalate

Methyltriethylammonium monomethyloxalate

Tetraethylammonium monomethyloxalate

n-Propyltriethylammonium mono-n-propyloxalate

n-Butyltriethylammonium mono-n-butyloxalate

Benzyltriethylammonium monobenzyloxalate

cyclohexyldimethylammonium monomethyloxalate

Dimethyl-phenylammonium monomethyloxalate.

Tetrabutylammonium monomethyloxalate

N-methylpyridinium monomethyloxalate

N-ethylpyridinium monoethyloxalate

N-n-propylpyridinium mono-n-propyloxalate

N-n-butylpyridinium mono-n-butyloxalate

N-benzylpyridinium monobenzyloxalate

N-methyl-isochinolinium monomethyloxalate

N-ethyl-isochinolinium monoethyloxalate

N-n-propyl-isochinolinium mono-n-propyloxalate

N-n-butyl-isochinolinium mono-n-butyloxalate

N-benzyl-isochinolinium monobenzyloxalate.

The present invention further relates to a process for the preparation of monosubstituted oxalic acid derivatives of the formula (I) as defined above and the use of the monosubstituted oxalic acid derivatives of the general formula (I) above (without disclaimer) for at least partially dissolving an inorganic or an organic material such as metal compounds, e.g. rare earth element compounds or actinide element compounds or the use of the monosubstituted oxalic acid derivatives of the general formula (I) above (without disclaimer) in a separation process for metals such as rare earth elements or actinide elements, e.g. in a liquid-liquid extraction process for the separation of rare earth elements.

Monomethyl oxalates of some quaternized organic ammonium compounds are known. The reaction of trimethylamine with oxalic acid dimethylester to the quaternary ammonium salt with a melting point of 125° C. is described by Willstatter and Kahn in Ber. Chem. Gesell. 1902, 35, 2757.

The reaction of one of the amines pyridine, isoquinoline, triethylamine or N,N-dimethyl-2-aminoethanol with symmetrical oxalic acid esters [R—O—C(O)—C(O)—R], wherein R is methyl, ethyl, n-propy, n-butyl or benzyl, to the quaternary ammonium salts is described by Kametani et al. in J. Heterocyl. Chem. 1966, 3, 129.

The reaction of pyridine with oxalic acid dimethylester to the quaternary ammonium salt is described by Kametani et al. in Yakugaku zasshi 1968, 88, 445 and by Dolenk and Modec in Acta Chim. Slov. 2008, 55, 752.

The preparation of quaternary ammonium salts from tertiary amines bearing alkyl substituents and oxalic acid dimethylester or oxalic acid diethylester is described in EP 2 033 945 A.

The use of imidazolium based organic liquids having anions different from oxalic acid derivatives in e.g. lanthanide speciation is described in I Billard et al., Radiochim Acta (2009), 355-359, the use of imidazolium based organic liquids having anions different from oxalic acid derivatives in extraction of e.g. lanthanides is described in I. Billard et al., Anal Bioanal Chem. (2011) 1555-1566 and in X. Sun et al., Talanta (2012), 132-137.

None of these state of the art does disclose the use of the monosubstituted oxalic acid derivatives of the general formula (I) above (without disclaimer) for at least partially dissolving an inorganic or an organic material such as metal compounds, e.g. rare earth element compounds or actinide element compounds or the use of the monosubstituted oxalic acid derivatives of the general formula (I) above (without disclaimer) in a separation process for metals such as rare earth elements or actinide elements, e.g. in a liquid-liquid extraction process for the separation of rare earth elements.

An object of the instant invention is to provide new ionic compounds and their use in dissolution and separation processes for inorganic or organic materials.

For the purpose of the present invention the expression C₁ to C₃₀ organic residue means an organic structural moiety containing one (1) to thirty (30) carbon atoms.

The C₁ to C₃₀ organic residue is for example selected from the group consisting of the following organic residues (I) to (X).

(I) For the purposes of the present invention, the expression “alkyl” comprises straight-chain or branched alkyl. This is preferably straight-chain or branched C₁-C₃₀-alkyl, in particular C₁-C₁₈-alkyl and very particularly preferably C₁-C₁₂-alkyl. Examples of alkyl groups are, in particular, methyl, ethyl, n-propyl, isopropyl, n-butyl, isobutyl, sec-butyl, tert-butyl, n-pentyl, isopentyl, 1-methylbutyl, tert-pentyl, neopentyl, n-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, n-heptyl, n-octyl, 1-methylheptyl, 2-ethylhexyl, 2,4,4-trimethyl-pentyl, 1,1,3,3-tetramethylbutyl, n-nonyl, n-decyl, n-undecyl, n-dodecyl, n-tridecyl, n-tetradecyl, n-pentadecyl, n-hexadecyl, n-heptadecyl, n-octadecyl and n-eicosyl.

The expression alkyl also comprises alkyl radicals whose carbon chain may be interrupted by one or more nonadjacent heteroatoms or heteroatom-comprising groups which are preferably selected from among —O—, —S—, —NR^{a}—, —PR^{a}—, —SiR^{a}R^{aa} and/or —SO₂. R^{a} is preferably hydrogen, alkyl, cycloalkyl, heterocycloalkyl, aryl or hetaryl. R^{aa} is preferably hydrogen, alkyl, cycloalkyl, heterocycloalkyl or aryl.

Examples of alkyl radicals whose carbon chains may be interrupted by one or two nonadjacent heteroatoms —O— are the following:

methoxymethyl, diethoxymethyl, 2-methoxyethyl, 2-ethoxyethyl, 2-propoxyethyl, diethoxyethyl, 2-butoxyethyl, 2-octyloxyethyl, 2-methoxypropyl, 3-methoxypropyl, 3-ethoxypropyl, 3-propoxypropyl, 2-isopropoxyethyl, 2-butoxypropyl, 3-butoxypropyl, 4-methoxybutyl, 4-ethoxybutyl, 4-propoxybutyl, 6-methoxyhexyl, 3,6-dioxaheptyl (5-methoxy-3-oxapentyl), 3,6-dioxaoctyl (7-methoxy-4-oxaheptyl), 4,8-dioxanonyl (7-methoxy-4-oxaheptyl), 3,7-dioxaoctyl, 3,7-dioxanonyl, 4,7-dioxaoctyl, 4,7-dioxanonyl, 2- and 4-butoxybutyl, 4,8-dioxadecyl, 9-ethoxy-5-oxanonyl.

Examples of alkyl radicals whose carbon chains may be interrupted by three or more than three nonadjacent heteroatoms —O— also include oligooxyalkylenes and polyoxyalkylenes, i.e. compounds having repeating units which are preferably selected from among (CH₂CH₂O)ₓ₁, (CH(CH₃)CH₂O)ₓ₂ and ((CH₂)₄O)ₓ₃, where x1, x2 and x3 are each, independently of one another, an integer from 3 to 100, preferably from 3 to 80. The sum of x1, x2 and x3 is an integer from 3 to 300, in particular from 3 to 100. In polyoxyalkylenes having two or three different repeating units, the repeating units can be present in any order, i.e. they can be randomly distributed, alternating or block-like repeating units. Examples are 3,6,9-trioxadecyl, 3,6,9-trioxaundecyl, 3,6,9-trioxadodecyl, 4,8,12-trioxamidecyl (11-methoxy-4,8-dioxaundecyl), 4,8,12-trioxatetradecyl, 14-methoxy-5,10-dioxatetradecyl, 5,10,15-trioxaheptadecyl, 3,6,9,12-tetraoxamidecyl, 3,6,9,12-tetraoxatetradecyl, 4,8,12,16-tetraoxaheptadecyl (15-methoxy-4,8,12-trioxapentadecyl), 4,8,12,16-tetraoxaoctadecyl and the like.

Examples of alkyl radicals whose carbon chains may be interrupted by one or more, e.g. 1, 2, 3, 4 or more than 4, nonadjacent heteroatoms —S— are the following:

butylthiomethyl, 2-methylthioethyl, 2-ethylthioethyl, 2-propylthioethyl, 2-butylthioethyl, 2-dodecylthioethyl, 3-methylthiopropyl, 3-ethylthiopropyl, 3-propylthiopropyl, 3-butylthiopropyl, 4-methylthiobutyl, 4-ethylthiobutyl, 4-propylthiobutyl, 3,6-dithiaheptyl, 3,6-dithiaoctyl, 4,8-dithianonyl, 3,7-dithiaoctyl, 3,7-dithianonyl, 2- and 4-butylthiobutyl, 4,8-dithiadecyl, 3,6,9-trithiadecyl, 3,6,9-trithiaundecyl, 3,6,9-trithiadodecyl, 3,6,9,12-tetrathiamidecyl and 3,6,9,12-tetrathiatetradecyl.

Examples of alkyl radicals whose carbon chains are interrupted by one or two nonadjacent heteroatom-comprising groups —NR^{a}— are the following:

2-monomethylaminoethyl and 2-monoethylaminoethyl, 2-dimethylaminoethyl, 3-methylaminopropyl, 2- and 3-dimethylaminopropyl, 3-monoisopropylaminopropyl, 2- and 4-monopropylaminobutyl, 2- and 4-dimethylaminobutyl, 6-methylaminohexyl, 6-dimethylaminohexyl, 6-methyl-3,6-diazaheptyl, 3,6-dimethyl-3,6-diazaheptyl, 3,6-diazaoctyl and 3,6-dimethyl-3,6-diazaoctyl.

Examples of alkyl radicals whose carbon chains may be interrupted by three or more than three nonadjacent heteroatom-comprising groups —NR^{a}— also include oligoalkylenimines and polyalkylenimines. What has been said above with regard to the polyoxyalkylenes applies analogously to polyalkylenimines, with the oxygen atom being in each case replaced by an NRa group, where R^{a} is preferably hydrogen or C₁-C₄-alkyl. Examples are 9-methyl-3,6,9-triazadecyl, 3,6,9-trimethyl-3,6,9-triazadecyl, 3,6,9-triazaundecyl, 3,6,9-trimethyl-3,6,9-triazaundecyl, 12-methyl-3,6,9,12-tetraazamidecyl, 3,6,9,12-tetramethyl-3,6,9,12-tetraazamidecyl and the like.

Examples of alkyl radicals whose carbon chains are interrupted by one or more, e.g. 1 or 2, nonadjacent —SO2-groups are 2-methylsulfonylethyl, 2-ethylsulfonylethyl, 2-propylsulfonylethyl, 2-isopropylsulfonylethyl, 2-butylsulfonylethyl, 2-methylsulfonylpropyl, 3-methylsulfonylpropyl, 2-ethylsulfonylpropyl, 3-ethylsulfonylpropyl, 2-propylsulfonylpropyl, 3-propylsulfonylpropyl, 2-butylsulfonylpropyl, 3-butylsulfonylpropyl, 2-methylsulfonylbutyl, 4-methylsulfonylbutyl, 2-ethylsulfonylbutyl, 4-ethylsulfonylbutyl, 2-propylsulfonylbutyl, 4-propylsulfonylbutyl and 4-butylsulfonylbutyl.

The expression alkyl also comprises substituted alkyl radicals. Substituted alkyl groups can, depending on the length of the alkyl chain, have one or more (e.g. 1, 2, 3, 4, 5 or more than 5) substituents. These are preferably selected independently from among cycloalkyl, cycloalkyloxy, polycyclyl, polycyclyloxy, heterocycloalkyl, aryl, aryloxy, arylthio, hetaryl, halogen, hydroxy, SH, ═O, ═S, ═NRa, COOH, carboxylate, SO3H, sulfonate, NE1E2, nitro and cyano, where E1 and E2 are each, independently of one another, hydrogen, alkyl, cycloalkyl, heterocycloalkyl, aryl or hetaryl. Cycloalkyl, cycloalkyloxy, polycycloalkyl, polycycloalkyloxy, heterocycloalkyl, aryl and hetaryl substituents of the alkyl groups may in turn be unsubstituted or substituted; suitable substituents are those mentioned below for these groups.

What has been said above with regard to alkyl also applies in principle to the alkyl parts of alkoxy, alkylamino, dialkylamino, alkylthio (alkylsulfanyl), alkylsulfinyl, alkylsulfonyl, etc. Suitable substituted alkyl radicals are the following:

alkyl substituted by carboxy, e.g. carboxymethyl, 2-carboxyethyl, 3-carboxypropyl, 4-carboxybutyl, 5-carboxypentyl, 6-carboxyhexyl, 7-carboxyheptyl, 8-carboxyoctyl, 9-carboxynonyl, 10-carboxydecyl, 12-carboxydodecyl and 14-carboxytetradecyl; alkyl substituted by SO₃H, e.g. sulfomethyl, 2-sulfoethyl, 3-sulfopropyl, 4-sulfobutyl, 5-sulfopentyl, 6-sulfohexyl, 7-sulfoheptyl, 8-sulfooctyl, 9-sulfononyl, 10-sulfodecyl, 12-sulfododecyl and 14-sulfotetradecyl;

alkyl substituted by carboxylate, for example alkoxycarbonylalkyl, e.g. methoxycarbonylmethyl, ethoxycarbonylmethyl, n-butoxycarbonylmethyl, 2-methoxycarbonylethyl, 2-ethoxycarbonylethyl, 2-methoxycarbonylpropyl, 2-ethoxycarbonylpropyl, 2-(n-butoxycarbonyl)propyl, 2-(4-n-butoxycarbonyl)propyl, 3-methoxycarbonylpropyl, 3-ethoxycarbonylpropyl, 3-(n-butoxycarbonyl)propyl, 3-(4-n-butoxycarbonyl)propyl, aminocarbonylalkyl, e.g. aminocarbonylmethyl, aminocarbonylethyl, aminocarbonylpropyl and the like; alkylaminocarbonylalkyl such as methylaminocarbonylmethyl, methylaminocarbonylethyl, ethylcarbonylmethyl, ethylcarbonylethyl and the like, or dialkylaminocarbonylalkyl such as dimethylaminocarbonylmethyl, dimethylaminocarbonylethyl, dimethylcarbonylpropyl, diethylaminocarbonylmethyl, diethylaminocarbonylethyl, diethylcarbonylpropyl and the like;

alkyl substituted by hydroxy, e.g. 2-hydroxyethyl, 2-hydroxypropyl, 3-hydroxypropyl, 3-hydroxybutyl, 4-hydroxybutyl, 2-hydroxy-2,2-dimethylethyl, 5-hydroxy-3-oxapentyl, 6-hydroxyhexyl, 7-hydroxy-4-oxaheptyl, 8-hydroxy-4-oxaoctyl, 8-hydroxy-3,6-dioxaoctyl, 9-hydroxy-5-oxanonyl, 11-hydroxy-4,8-dioxaundecyl, 11-hydroxy-3,6,9-trioxaundecyl, 14-hydroxy-5,10-dioxatetradecyl, 15-hydroxy-4,8,12-trioxapentadecyl and the like;

alkyl substituted by amino, e.g. 2-aminoethyl, 2-aminopropyl, 3-aminopropyl, 4-aminobutyl, 6-aminohexyl and the like;

alkyl substituted by cyano, e.g. 2-cyanoethyl, 3-cyanopropyl, 3-cyanobutyl and 4-cyanobutyl; alkyl substituted by halogen as defined below, where the hydrogen atoms in the alkyl group may be partly or completely replaced by halogen atoms, e.g. C₁-C₁₈-fluoroalkyl, e.g. trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl and the like, C₁-C₁₈-chloroalkyl, e.g. chloromethyl, dichloromethyl, trichloromethyl, 2-chloroethyl, 2- and 3-chloropropyl, 2-, 3- and 4-chlorobutyl, 1,1-dimethyl-2-chloroethyl and the like, C₁-C₁₈-bromoalkyl, e.g. bromoethyl, 2-bromoethyl, 2- and 3-bromopropyl and 2-, 3- and 4-bromobutyl and the like;

alkyl substituted by nitro, e.g. 2-nitroethyl, 2- and 3-nitropropyl and 2-, 3- and 4-nitrobutyl and the like;

alkyl substituted by cycloalkyl, e.g. cyclopentylmethyl, 2-cyclopentylethyl, 3-cyclopentylpropyl, cyclohexylmethyl, 2-cyclohexylethyl, 3-cyclohexylpropyl and the like;

alkyl substituted by ═O (oxo group), e.g. 2-oxopropyl, 2-oxobutyl, 3-oxobutyl, 1-methyl-2-oxopropyl, 2-oxopentyl, 3-oxopentyl, 1-methyl-2-oxobutyl, 1-methyl-3-oxobutyl, 2-oxohexyl, 3-oxohexyl, 4-oxohexyl, 2-oxoheptyl, 3-oxoheptyl, 4-oxoheptyl, 4-oxoheptyl and the like;

alkyl substituted by ═S (thioxo group) e.g. 2-thioxopropyl, 2-thioxobutyl, 3-thioxobutyl, 1-methyl-2-thioxopropyl, 2-thioxopentyl, 3-thioxopentyl, 1-methyl-2-thioxobutyl, 1-methyl-3-thioxobutyl, 2-thioxohexyl, 3-thioxohexyl, 4-thioxohexyl, 2-thioxoheptyl, 3-thioxoheptyl, 4-thioxoheptyl, 4-thioxoheptyl and the like;

alkyl substituted by ═NRa, preferably a group of the type in which R^{a} is hydrogen or C₁-C₄-alkyl, e.g. 2-iminopropyl, 2-iminobutyl, 3-iminobutyl, 1-methyl-2-iminopropyl, 2-iminopentyl, 3-iminopentyl, 1-methyl-2-iminobutyl, 1-methyl-3-innino-butyl, 2-iminohexyl, 3-iminohexyl, 4-iminohexyl, 2-iminoheptyl, 3-iminoheptyl, 4-iminoheptyl, 4-iminoheptyl, 2-methyliminopropyl, 2-methyliminobutyl, 3-methyliminobutyl, 1-methyl-2-methyliminopropyl, 2-methyliminopentyl, 3-methyliminopentyl, 1-methyl-2-nnethyliminobutyl, 1-methyl-3-nnethylinninobutyl, 2-methyliminohexyl, 3-methyliminohexyl, 4-methyliminohexyl, 2-methyliminoheptyl, 3-methyliminoheptyl, 4-methyliminoheptyl, 4-methyliminoheptyl, 2-ethyliminopropyl, 2-ethyliminobutyl, 3-ethyliminobutyl, 1-methyl-2-ethyliminopropyl, 2-ethyliminopentyl, 3-ethyliminopentyl, 1-methyl-2-ethyliminobutyl, 1-methyl-3-ethyliminobutyl, 2-ethyliminohexyl, 3-ethyliminohexyl, 4-ethyliminohexyl, 2-ethyliminoheptyl, 3-ethyliminoheptyl, 4-ethyliminoheptyl, 4-ethyliminoheptyl, 2-propyliminopropyl, 2-propyliminobutyl, 3-propyliminobutyl, 1-methyl-2-propyliminopropyl, 2-propyliminopentyl, 3-propyliminopentyl, 1-methyl-2-propyliminobutyl, 1-methyl-3-propyliminobutyl, 2-propyliminohexyli, 3-propyliminohexyl, 4-propyliminohexyl, 2-propyliminoheptyl, 3-propyliminoheptyl, 4-propyliminoheptyl, 4-propyliminoheptyl and the like.

Alkoxy is an alkyl group bound via an oxygen atom. Examples of alkoxy are: methoxy, ethoxy, n-propoxy, 1-methylethoxy, butoxy, 1-methylpropoxy, 2-methylpropoxy, 1,1-dimethylethoxy, n-pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy or 1-ethyl-2-methylpropoxy, hexoxy and also R^{A}O—(CH₂CH₂CH₂CH₂O)ₙ—CH₂CH₂CH₂CH₂O— where R^{A} is hydrogen or C₁-C₄-alkyl, preferably hydrogen, methyl or ethyl, and n is from 0 to 10, preferably from 0 to 3.

Alkylthio (alkylsulfanyl) is an alkyl group bound via a sulfur atom. Examples of alkylthio are methylthio, ethylthio, propylthio, butylthio, pentylthio and hexylthio.

Alkylsulfinyl is an alkyl group bound via an S(═O) group.

Alkylsulfonyl is an alkyl group bound via an S(═O)₂ group.

Aryl-substituted alkyl radicals (“arylalkyl”) have at least one unsubstituted or substituted aryl group as defined below. Suitable substituents on the aryl group are those mentioned below. The alkyl group in “arylalkyl” can bear at least one further substituent as defined above and/or be interrupted by one or more nonadjacent heteroatoms or heteroatom-comprising groups selected from among —O—, —S—, —NRa— and —SO₂—. Arylalkyl is preferably phenyl-C1-C₁₀-alkyl, particularly preferably phenyl-C1-C4-alkyl, e.g. benzyl, 1-phenethyl, 2-phenethyl, 1-phenprop-1-yl, 2-phenprop-1-yl, 3-phenprop-1-yl, 1-phenbut-1-yl, 2-phenbut-1-yl, 3-phenbut-1-yl, 4-phenbut-1-yl, 1-phenbut-2-yl, 2-phenbut-2-yl, 3-phenbut-2-yl, 4-phenbut-2-yl, 1-(phenmeth)-eth-1-yl, 1-(phenmethyl)-1-(methyl)-eth-1-yl or -(phenmethyl)-1-(methyl)-prop-1-yl; preferably benzyl and 2-phenethyl.

(II) For the purposes of the present invention, the expression “alkenyl” comprises straight-chain and branched alkenyl groups which can, depending on the length of the chain, have one or more double bonds (e.g. 1, 2, 3, 4 or more than 4). Preference is given to C₂-C₁₈-alkenyl, particularly preferably C₂-C₁₂-alkenyl groups. The expression “alkenyl” also comprises substituted alkenyl groups which may bear one or more (e.g. 1, 2, 3, 4, 5 or more than 5) substituents. Suitable substituents are, for example, selected from among ═O, ═S, ═NRa, cycloalkyl, cycloalkyloxy, polycyclyl, polycyclyloxy, heterocycloalkyl, aryl, aryloxy, arylthio, hetaryl, halogen, hydroxy, SH, COOH, carboxylate, SO₃H, sulfonate, alkylsulfinyl, alkylsulfonyl, NE³E⁴, nitro and cyano, where E³ and E⁴ are each, independently of one another, hydrogen, alkyl, cycloalkyl, heterocycloalkyl, aryl or hetaryl.

The expression “alkenyl” also comprises alkenyl radicals whose carbon chain may be interrupted by one or more nonadjacent heteroatoms or heteroatom-comprising groups which are preferably selected from among —O—, —S—, —NR^{a}— and —SO₂—.

Alkenyl is then, for example, ethenyl (vinyl), 1-propenyl, 2-propenyl, 1-methylethenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, penta-1,3-dien-1-yl, hexa-1,4-dien-1-yl, hexa-1,4-dien-3-yl, hexa-1,4-dien-6-yl, hexa-1,5-dien-1-yl, hexa-1,5-dien-3-yl, hexa-1,5-dien-4-yl, hepta-1,4-dien-1-yl, hepta-1,4-dien-3-yl, hepta-1,4-dien-6-yl, hepta-1,4-dien-7-yl, hepta-1,5-dien-1-yl, hepta-1,5-dien-3-yl, hepta-1,5-dien-4-yl, hepta-1,5-dien-7-yl, hepta-1,6-dien-1-yl, hepta-1,6-dien-3-yl, hepta-1,6-dien-4-yl, hepta-1,6-dien-5-yl, hepta-1,6-dien-2-yl, octa-1,4-dien-1-yl, octa-1,4-dien-2-yl, octa-1,4-dien-3-yl, octa-1,4-dies-6-yl, octa-1,4-dien-7-yl, octa-1,5-dien-1-yl, octa-1,5-dien-3-yl, octa-1,5-dien-4-yl, octa-1,5-dien-7-yl, octa-1,6-dien-1-yl, octa-1,6-dien-3-yl, octa-1,6-dien-4-yl, octa-1,6-dien-5-yl, octa-1,6-dien-2-yl, deca-1,4-dienyl, deca-1,5-dienyl, deca-1,6-dienyl, deca-1,7-dienyl, deca-1,8-dienyl, deca-2,5-dienyl, deca-2,6-dienyl, deca-2,7-dienyl, deca-2,8-dienyl and the like.

(III) For the purposes of the present invention, the expression “cycloalkyl” comprises both unsubstituted and substituted monocyclic saturated hydrocarbon groups which generally have from 3 to 12 ring carbons, (C₃-C₁₂-cycloalkyl groups) such as cyclopropyl, cyclobutyl, cyclopentyl, cyclohexyl, cycloheptyl, cyclooctyl, cyclononyl, cyclodecyl, cycloundecyl or cyclododecyl, in particular C₅-C₁₂-cycloalkyl. Suitable substituents are generally selected from among the substituents mentioned above for alkyl groups, alkoxy and alkylthio. Substituted cycloalkyl groups can have one or more (e.g. 1, 2, 3, 4, 5 or more than 5) substituents, and in the case of halogen the cycloalkyl radical is partially or completely substituted by halogen.

Examples of cycloalkyl groups are cyclopentyl, 2- and 3-methylcyclopentyl, 2- and 3-ethylcyclopentyl, chloropentyl, dichloropentyl, dimethylcyclopentyl, cyclohexyl, 2-, 3- and 4-methylcyclohexyl, 2-, 3- and 4-ethylcyclohexyl, 3- and 4-propylcyclohexyl, 3- and 4-isopropylcyclohexyl, 3- and 4-butylcyclohexyl, 3- and 4-sec-butylcyclohexyl, 3- and 4-tert-butylcyclohexyl, chlorohexyl, dimethylcyclohexyl, diethylcyclohexyl, methoxycyclohexyl, dimethoxycyclohexyl, diethoxycyclohexyl, butoxycyclohexyl, methylthiocyclohexyl, chlorocyclohexyl, dichlorocyclohexyl, cycloheptyl, 2-, 3- and 4-methylcycloheptyl, 2-, 3- and 4-ethylcycloheptyl, 3- and 4-propylcycloheptyl, 3- and 4-isopropylcycloheptyl, 3- and 4-butylcycloheptyl, 3- and 4-sec-butylcycloheptyl, 3- and 4-tert-butylcycloheptyl, cyclooctyl, 2-, 3-, 4- and 5-methylcyclooctyl, 2-, 3-, 4- and 5-ethylcyclooctyl, 3-, 4- and 5-propylcyclooctyl, partially fluorinated cycloalkyl and perfluorinated cycloalkyl of the formula CₙF_{2(n-a)-(1-b)}H_{2a-b} where n=5 to 12, 0<=a<=n and b=0 or 1.

Cycloalkyloxy is a cycloalkyl group as defined above bound via oxygen.

(IV) The expression “cycloalkenyl” comprises unsubstituted and substituted, singly or doubly unsaturated hydrocarbon groups having from 3 to 5, up to 8, up to 12, preferably from 5 to 12, ring carbons, e.g. cyclopent-1-en-1-yl, cyclopent-2-en-1-yl, cyclopent-3-en-1-yl, cyclohex-1-en-1-yl, cyclohex-2-en-1-yl, cyclohex-3-en-1-yl, cyclohexa-2,5-dien-1-yl and the like. Suitable substituents are those mentioned above for cycloalkyl.

Cycloalkenyloxy is a cycloalkenyl group as defined above bound via oxygen.

(V) For the purposes of the present invention, the expression “polycyclyl” comprises in the broadest sense compounds which comprise at least two rings, regardless of how these rings are linked. These can be carbocyclic and/or heterocyclic rings. The rings can be saturated or unsaturated. The rings can be linked via a single or double bond (“multiring compounds”) joined by fusion (“fused ring systems”) or bridged (“bridged ring systems”, “cage compounds”). Preferred polycyclic compounds are bridged ring systems and fused ring systems. Fused ring systems can be aromatic, hydroaromatic and cyclic compounds joined by fusion (fused compounds). Fused ring systems comprise two, three or more than three rings. Depending on the way in which the rings are joined in fused ring systems, a distinction is made between orthofusion, i.e. each ring shares an edge or two atoms with each adjacent ring, and peri-fusion in which a carbon atom belongs to more than two rings. Among fused ring systems, preference is given to ortho-fused ring systems. For the purposes of the present invention, bridged ring systems include systems which do not belong to the multiring ring systems nor to the fused ring systems and in which at least two ring atoms belong to at least two different rings. Among the bridged ring systems, a distinction is made according to the number of ring opening reactions which are formally required to obtain an open-chain compound between bicyclo, tricyclo, tetracyclo compounds, etc., which comprise two, three, four, etc., rings. The expression “bicycloalkyl” comprises bicyclic hydrocarbon radicals which preferably have from 5 to 10 carbon atoms, e.g. bicyclo[2.2.1]hept-1-yl, bicyclo[2.2.1]hept-2-yl, bicyclo[2.2.1]hept-7-yl, bicyclo[2.2.2]oct-1-yl, bicyclo[2.2.2]oct-2-yl, bicyclo[3.3.0]octyl, bicyclo[4.4.0]decyl and the like. The expression “bicycloalkenyl” comprises monounsaturated, bicyclic hydrocarbon radicals which preferably have from 5 to 10 carbon atoms, e.g. bicyclo[2.2.1]hept-2-en-1-yl.

(VI) For the purposes of the present invention, the expression “aryl” comprises aromatic hydrocarbon radicals which have one or more rings and may be unsubstituted or substituted. The term aryl generally refers to hydrocarbon radicals having from 6 to 10, up to 14, up to 18, preferably from 6 to 10, ring carbons. Aryl is preferably unsubstituted or substituted phenyl, naphthyl, anthracenyl, phenanthrenyl, naphthacenyl, chrysenyl, pyrenyl, etc., and particularly preferably phenyl or naphthyl. Substituted aryls can, depending on the number and size of their ring systems, have one or more (e.g. 1, 2, 3, 4, 5 or more than 5) substituents. These are preferably selected independently from among alkyl, alkoxy, cycloalkyl, cycloalkyloxy, heterocycloalkyl, aryl, aryloxy, arylthio, hetaryl, halogen, hydroxy, SH, alkylthio, alkylsulfinyl, alkylsulfonyl, COOH, carboxylate, SO₃H, sulfonate, NE⁵E⁶, nitro and cyano, where E⁵ and E⁶ are each, independently of one another, hydrogen, alkyl, cycloalkyl, cycloalkyloxy, polycyclyl, polycyclyloxy, heterocycloalkyl, aryl, aryloxy or hetaryl. Aryl is particularly preferably phenyl which, if it is substituted, can generally bear 1, 2, 3, 4 or 5 substituents, preferably 1, 2 or 3 substituents.

Aryl which bears one or more radicals is, for example, 2-, 3- and 4-methylphenyl, 2,4-, 2,5-, 3,5- and 2,6-dimethylphenyl, 2,4,6-trimethylphenyl, 2-, 3- and 4-ethylphenyl, 2,4-, 2,5-, 3,5- and 2,6-diethylphenyl, 2,4,6-triethylphenyl, 2-, 3- and 4-propylphenyl, 2,4-, 2,5-, 3,5- and 2,6-dipropylphenyl, 2,4,6-tripropylphenyl, 2-, 3- and 4-isopropylphenyl, 2,4-, 2,5-, 3,5- and 2,6-diisopropylphenyl, 2,4,6-triisopropylphenyl, 2-, 3- and 4-butylphenyl, 2,4-, 2,5-, 3,5- and 2,6-dibutylphenyl, 2,4,6-tributylphenyl, 2-, 3- and 4-isobutylphenyl, 2,4-, 2,5-, 3,5- and 2,6-diisobutylphenyl, 2,4,6-triisobutylphenyl, 2-, 3- and 4-sec-butylphenyl, 2,4-, 2,5-, 3,5- and 2,6-disec-butylphenyl, 2,4,6-tri-sec-butylphenyl, 2-, 3- and 4-tert-butylphenyl, 2,4-, 2,5-, 3,5- and 2,6-di-tert-butylphenyl, 2,4,6-tri-tert-butylphenyl and 2-, 3-, 4-dodecylphenyl; 2-, 3- and 4-methoxyphenyl, 2,4-, 2,5-, 3,5- and 2,6-dimethoxyphenyl, 2,4,6-trimethoxyphenyl, 2-, 3- and 4-ethoxyphenyl, 2,4-, 2,5-, 3,5- and 2,6-diethoxyphenyl, 2,4,6-triethoxyphenyl, 2-, 3- and 4-propoxyphenyl, 2,4-, 2,5-, 3,5- and 2,6-dipropoxyphenyl, 2-, 3- and 4-isopropoxyphenyl, 2,4-, 2,5-, 3,5- and 2,6-diisopropoxyphenyl, 2-, 3- and 4-butoxyphenyl, 2-, 3-, 4-hexyloxyphenyl; 2-, 3-, 4-chlorophenyl, 2,4-, 2,5-, 3,5- and 2,6-dichlorophenyl, trichlorophenyl, 2-, 3-, 4-fluorophenyl, 2,4-, 2,5-, 3,5- and 2,6-difluorophenyl, trifluorophenyl, for example 2,4,6-trifluorophenyl, tetrafluorophenyl, pentafluorophenyl, 2-, 3- and 4-cyanophenyl; 2-nitrophenyl, 4-nitrophenyl, 2,4-dinitrophenyl, 2,6-dinitrophenyl; 4-dimethylaminophenyl; 4-acetylphenyl; methoxyethylphenyl, ethoxymethylphenyl; methylthiophenyl, isopropylthiophenyl or tert-butylthiophenyl; methylnaphthyl; isopropylnaphthyl or ethoxynaphthyl. Examples of substituted aryl in which two substituents bound to adjacent carbon atoms of the aryl ring form a fused ring or fused ring system are indenyl and fluorenyl.

For the purposes of the present invention, the expression “aryloxy” refers to aryl bound via an oxygen atom.

For the purposes of the present invention, the expression “arylthio” refers to aryl bound via a sulfur atom.

(VII) For the purposes of the present invention, the expression “heterocycloalkyl” comprises nonaromatic, unsaturated or fully saturated, cycloaliphatic groups which generally have from 5 to 8 ring atoms, for example 5 or 6 ring atoms, and in which 1, 2 or 3 of the ring carbons have been replaced by heteroatoms selected from among oxygen, nitrogen, sulfur and an —NR^{a}— group and which are unsubstituted or substituted by one or more, for example, 1, 2, 3, 4, 5 or 6, C₁-C₆-alkyl groups. Examples of such heterocycloaliphatic groups are pyrrolidinyl, piperidinyl, 2,2,6,6-tetramethylpiperidinyl, imidazolidinyl, pyrazolidinyl, oxazolidinyl, morpholidinyl, thiazolidinyl, isothiazolidinyl, isoxazolidinyl, piperazinyl, tetrahydrothienyl, dihydrothienyl, tetrahydrofuranyl, dihydrofuranyl, tetrahydropyranyl, 1,2-oxazolin-5-yl, 1,3-oxazolin-2-yl and dioxanyl. Nitrogen-comprising heterocycloalkyl can in principle be bound either via a carbon atom or via a nitrogen atom.

(VIII) For the purposes of the present invention, the expression “heteroaryl (hetaryl)” comprises unsubstituted or substituted, heteroaromatic groups which have one or more rings and generally have from 5 to 14 ring atoms, preferably 5 or 6 ring atoms, in which 1, 2 or 3 of the ring carbons have been replaced by one, two, three or four heteroatoms selected from among O, N, —NR^{a}— and S, e.g. furyl, thienyl, oxazolyl, isoxazolyl, thiazolyl, isothiazolyl, benzofuranyl, benzthiazolyl, benzimidazolyl, pyridyl, quinolinyl, acridinyl, pyridazinyl, pyrimidinyl, pyrazinyl, pyrrolyl, imidazolyl, pyrazolyl, indolyl, purinyl, indazolyl, benzotriazolyl, 1,2,3-triazolyl, 1,3,4-triazolyl and carbazolyl, where these heterocycloaromatic groups may, if they are substituted, generally bear 1, 2 or 3 substituents. The substituents are generally selected from among C₁-C₆-alkyl, C₁-C₆-alkoxy, hydroxy, carboxy, halogen and cyano.

5- to 7-membered nitrogen-comprising heterocycloalkyl or heteroaryl radicals which may optionally comprise further heteroatoms are, for example, pyrrolyl, pyrazolyl, imidazolyl, triazolyl, pyrrolidinyl, pyrazolinyl, pyrazolidinyl, imidazolinyl, imidazolidinyl, pyridinyl, pyridazinyl, pyrimidinyl, pyrazinyl, triazinyl, piperidinyl, piperazinyl, oxazolyl, isoxazolyl, thiazolyl, isothiazolyl, indolyl, quinolinyl, isoquinolinyl or quinaldinyl which may be unsubstituted or substituted as mentioned above.

(IX) For the purposes of the present invention, carboxylate and sulfonate are preferably a derivative of a carboxylic acid function or a sulfonic acid function, in particular a metal carboxylate or sulfonate, a carboxylic ester or sulfonic ester function or a carboxamide or sulfonamide function. These include, for example, esters with C1-β4-alkanols such as methanol, ethanol, n-propanol, isopropanol, n-butanol, sec-butanol and tert-butanol.

(X) For the purposes of the present invention, the expression “acyl” refers to alkanoyl, hetaroyl or aroyl groups which generally have from 1 to 11, preferably from 2 to 8, carbon atoms, for example the formyl, acetyl, propanoyl, butanoyl, pentanoyl, hexanoyl, heptanoyl, 2-ethylhexanoyl, 2-propylheptanoyl, benzoyl or naphthoyl group.

Halogen is fluorine, chlorine, bromine or iodine herein.

Suitable monosubstituted oxalic acid derivatives of the general formula (I) have a molar mass of less than 1000 g/mol, preferably less than 600 g/mol and in particular less than 400 g/mol.

The meaning of the substituents and terms in formula (I) is the following:

[A]⁺ is a cation made from an organic moiety A having a formally positively charged heteroatom selected from the group consisting of nitrogen, phosphorus and sulfur, preferably from nitrogen and phosphorus. The organic moiety which contains the formally positively charged heteroatom can be linear or cyclic. The organic moiety which contains a nitrogen atom as formally positively charged heteroatom is preferably cyclic and does for example include the respective compounds mentioned under the groups (VII) and (VIII) above. The organic moiety which contains a nitrogen atom as formally positively charged heteroatom is more preferably a five-membered heterocycle having one formally positively charged nitrogen atom and may further contain one or more other heteroatoms which are not formally positively charged.

Notwithstanding the foregoing the following compounds are disclaimed as compounds (I) as such, however not their use as described below is disclaimed:

Tetramethylammonium monomethyloxalate

Methyltri(alkyl)ammonium monomethyloxalate

Trimethyl(1-hydroxyethyl)ammonium monomethyloxalate

Methyltriethylammonium monomethyloxalate

Tetraethylammonium monomethyloxalate n-Propyltriethylammonium mono-n-propyloxalate n-Butyltriethylammonium mono-n-butyloxalate

Benzyltriethylammonium monobenzyloxalate

cyclohexyldimethylammonium monomethyloxalate

Dimethyl-phenylammonium monomethyloxalate.

Tetrabutylammonium monomethyloxalate

N-methylpyridinium monomethyloxalate

N-ethylpyridinium monoethyloxalate

N-n-propylpyridinium mono-n-propyloxalate

N-n-butylpyridinium mono-n-butyl-oxalate

N-benzylpyridinium monobenzyloxalate

N-methyl-isochinolinium monomethyloxalate

N-ethyl-isochinolinium monoethyloxalate

N-n-propyl-isochinolinium mono-n-propyloxalate

N-n-butyl-isochinolinium mono-n-butyloxalate

N-benzyl-isochinolinium monobenzyloxalate

Preferably [A]⁺ is selected from among the compounds of the formulae (IV.a) to (IV.z), however not including [A]⁺ of the above disclaimed compounds to the extent they relate to the composition of matter claims:

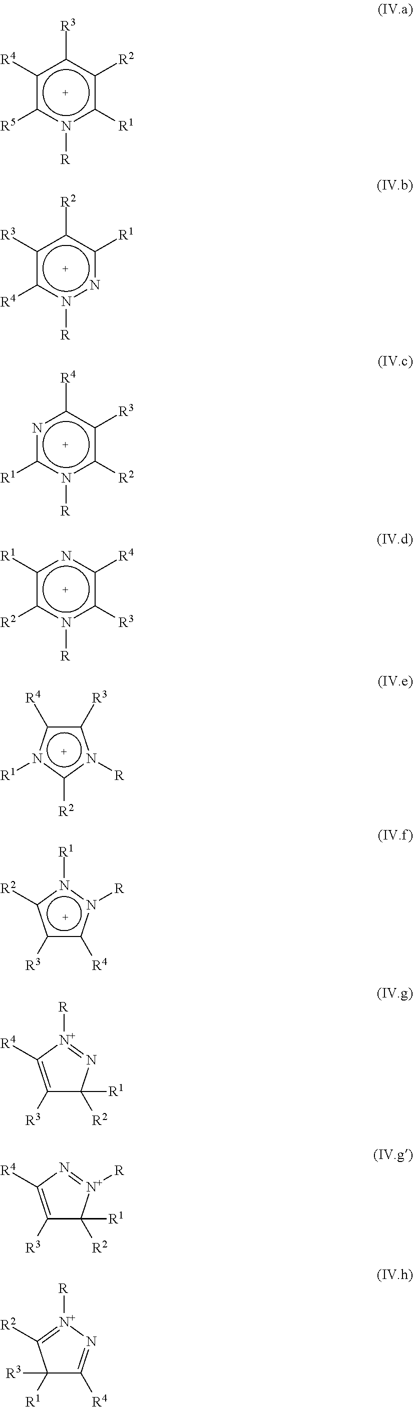

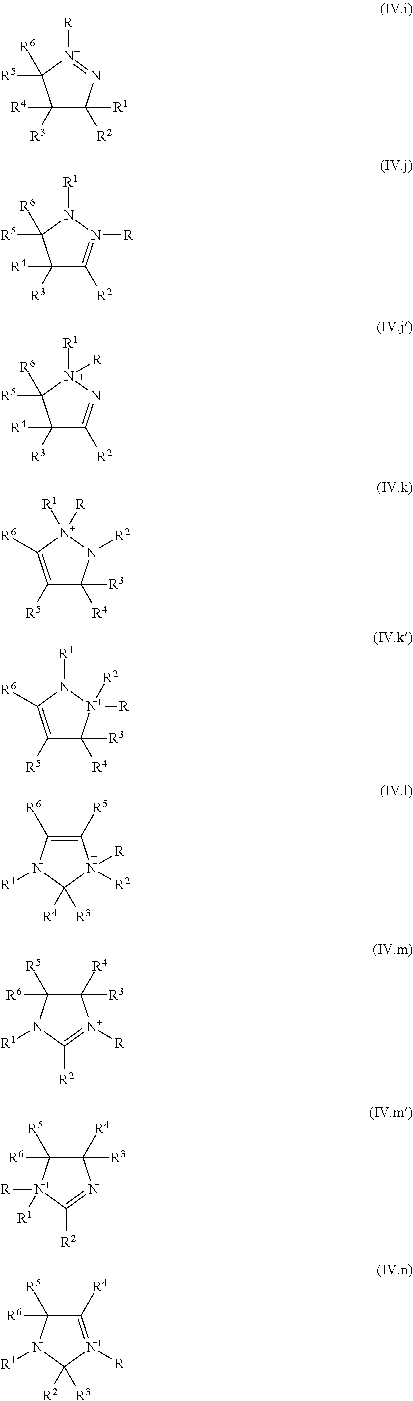

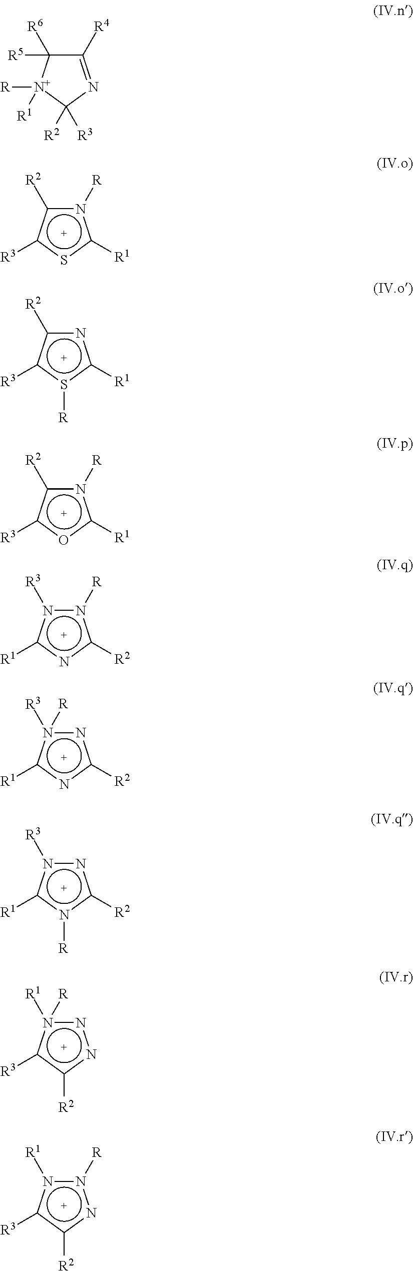

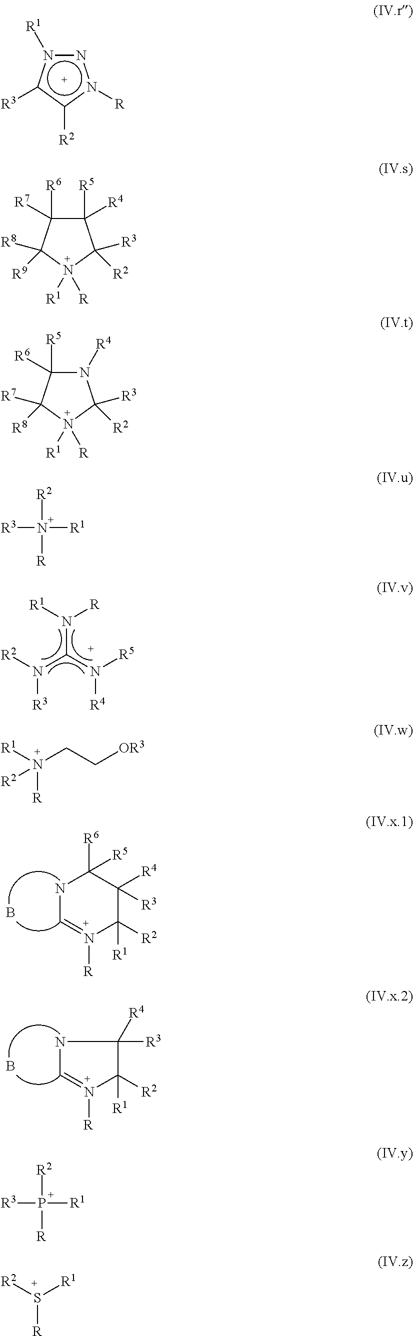

and oligomers comprising these structures, where
R is a C₁ to C₃₀ organic residue as defined above, which can be preferably selected from residues defined herein under groups (I) to (VIII) above, for example substituted or unsubstituted “alkyl”, “arylalkyl”, “alkenyl”, “cycloalkyl”, “cycloalkenyl”, “polycyclyl”, “aryl”, “aryloxy”, “arylthio”, “heterocycloalkyl”, “heteroarayl”, very preferably a straight chain or branched C1 to 030 alkyl and most preferably unsubstituted straight chain or branched C₁ to C₃₀ “alkyl” residues as defined in group (I) above, for example methyl, ethyl, propyl, butyl, pentyl, hexyl, heptyl, octyl, nonyl, decyl, undecyl, dodecyl;
radicals R¹, R², R³, R⁴, R⁵, R⁶, R⁷, R⁸ and R⁹ which are bound to a ring carbon are each, independently of one another, hydrogen, a sulfo group, COOH, carboxylate, sulfonate, acyl, alkoxycarbonyl, cyano, halogen, hydroxyl, SH, nitro, NE¹E², alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy or heteroaryl, where E¹ and E² are each, independently of one another, hydrogen, alkyl, cycloalkyl, heterocycloalkyl, aryl or hetaryl,
radicals R¹, R², R³, R⁴, R⁵, R⁶, R⁷, R⁸ and R⁹ which are bound to a ring heteroatom are each hydrogen, SO₃H, NE¹E², alkyl, alkoxy, alkenyl, cycloalkyl, cycloalkenyl, polycyclyl, heterocycloalkyl, aryl or heteroaryl, where E¹ and E² are each, independently of one another, hydrogen, alkyl, cycloalkyl, heterocycloalkyl, aryl or hetaryl, or
   two adjacent radicals R¹ to R⁹ together with the ring atoms to which they are bound may also form at least one fused-on, saturated, unsaturated or aromatic ring or a ring system having from 1 to 30 carbon atoms, where the ring or the ring system may have from 1 to 5 nonadjacent heteroatoms or heteroatom-comprising groups and the ring or the ring system may be unsubstituted or substituted,
   two geminal radicals R¹ to R⁹ may also together be ═O, ═S or ═NR^{b}, where R^{b} is hydrogen, alkyl, cycloalkyl, aryl or heteroaryl,
   and R¹ and R³ or R³ and R⁵ in the compounds of the formula (IV.x.1) may together also represent the second part of a double bond between the ring atoms bearing these radicals,
B in the compounds of the formulae (IV.x.1) and (IV.x.2) together with the C—N group to which it is bound forms a 4- to 8-membered, saturated or unsaturated or aromatic ring which may optionally be substituted and/or may optionally have further heteroatoms or heteroatom-comprising groups and/or may comprise further fused-on, saturated, unsaturated or aromatic carbocycles or heterocycles.

As regards the general meaning of the abovementioned radicals carboxylate, sulfonate, acyl, alkoxycarbonyl, halogen, NE¹E², alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy or heteroaryl, what has been said above applies in full. Radicals R¹ to R⁹ in the abovementioned formulae (IV) which are bound to a carbon atom and have a heteroatom or a heteroatom-comprising group can also be bound directly via a heteroatom to the carbon atom.

If two adjacent radicals R¹ to R⁹ together with the ring atoms to which they are bound form at least one fused-on, saturated, unsaturated or aromatic ring or a ring system having from 1 to 30 carbon atoms, where the ring or ring system can have from 1 to 5 nonadjacent heteroatoms or heteroatom-comprising groups and the ring or the ring system may be unsubstituted or substituted, these radicals can together as fused-on building blocks preferably be 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C1-C4-alkyl-1-aza-1,3-propenylene, 1,4-buta-1,3-dienylene, 1-aza-1,4-buta-1,3-dienylene or 2-aza-1,4-buta-1,3-dienylene.

The radical R is for example
unsubstituted C₁-C₁₈-alkyl such as methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl and 1-octadecyl;
C₁-C₁₈-alkyl substituted by one or more hydroxy, halogen, phenyl, cyano, C₁-C₆-alkoxycarbonyl and/or SO₃H groups, especially hydroxy-C₁-C₁₈-alkyl such as 2-hydroxyethyl or 6-hydroxyhexyl; phenyl-C₁-C₁₈-alkyl, such as benzyl, 3-phenylpropyl; cyano-C₁-C₁₈-alkyl, such as 2-cyanoethyl; C₁-C₆-alkoxy-C₁-C₁₈-alkyl, such as 2-(methoxycarbonyl)ethyl, 2-(ethoxycarbonyl)ethyl or 2-(n-butoxycarbonyl)ethyl; C₁-C₁₈-fluoroalkyl such as trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl; sulfo-C₁-C₁₈-alkyl such as 3-sulfopropyl; hydroxyethyloxyalkyl, radicals of oligoalkylene and polyalkylene glycols such as polyethylene glycols and polypropylene glycols and their oligomers having 2 to 100 units and a hydrogen or a C1-C8-alkyl as end group, for example
R^{A}O—(CHR^{B}—CH₂—O)ₙ—CHRB—CH₂— where R^{A} and R^{B} are preferably each hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl; and
C₂-C₆-alkenyl such as vinyl or propenyl.

Preference is given to the radicals R¹ to R⁹ each being, independently of one another,
hydrogen;
halogen;
a functional group selected from among hydroxy, alkoxy, alkylthio, carboxyl, —COOH, sulfonate, cyano, acyl, alkoxycarbonyl, NE¹E² and nitro, where E¹ and E² are as defined above;
C₁-C₁₈-alkyl which is unsubstituted or substituted as defined above and/or may, as defined above, be interrupted by at least one heteroatom or heteroatom-comprising group;
C₂-C₁₈-alkenyl which is unsubstituted or substituted as defined above and/or may, as defined above, be interrupted by at least one heteroatom;
C₆-C₁₀-aryl which is unsubstituted or substituted as defined above;
C₅-C₁₂-cycloalkyl which is unsubstituted or substituted as defined above;
polycyclyl which is unsubstituted or substituted as defined above;
C₅-C₁₂-cycloalkenyl which is unsubstituted or substituted as defined above;
heterocycloalkyl having 5 or 6 ring atoms, where the ring comprises, apart from ring carbons, 1, 2 or 3 heteroatoms or heteroatom-comprising groups selected from among oxygen, nitrogen, sulfur and NRa and is unsubstituted or substituted as defined above;
heteroaryl having from 5 to 10 ring atoms, where the ring has, apart from ring carbons, 1, 2 or 3 heteroatoms or heteroatom-comprising groups selected from among oxygen, nitrogen, sulfur and NRa and is unsubstituted or substituted as defined above.

Preference is likewise given to two adjacent radicals R¹ to R⁹ together with the ring atoms to which they are bound forming at least one fused-on, saturated, unsaturated or aromatic ring or ring system having from 1 to 12 carbon atoms, where the ring or ring system may have from 1 to 5 nonadjacent heteroatoms or heteroatom-comprising groups which are preferably selected from among oxygen, nitrogen, sulfur and NRa and the ring or the ring system may be unsubstituted or substituted, where the substituents are preferably selected independently from among alkoxy, cycloalkyl, cycloalkoxy, polycyclyl, polycyclyloxy, heterocycloalkyl, aryl, aryloxy, arylthio, heteroaryl halogen, hydroxy, SH, ═O, ═S, ═NR^{a}, COOH, carboxylate, —SO₃H, sulfonate, NE¹E², nitro and cyano, where E¹ and E² are each, independently of one another, hydrogen, alkyl, cycloalkyl, heterocycloalkyl, aryl or hetaryl.

If R¹ to R⁹ are alkoxy, then R¹ to R⁹ are preferably methoxy or ethoxy or R^{A}O—(CH₂CH₂CH₂CH₂O)ₙ—CH₂CH₂CH₂CH₂O— where R^{A} and R^{B} are preferably each hydrogen, methyl or ethyl and n is preferably from 0 to 3.

If R¹ to R⁹ are acyl, then R¹ to R⁹ are preferably formyl or C₁-C₄-alkylcarbonyl, in particular formyl or acetyl.

If R¹ to R⁹ are C₁-C₁₈-alkyl, then R¹ to R⁹ are preferably unsubstituted C₁-C₁₈-alkyl such as methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-9-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethyl-pentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl;

C₁-C₁₈-haloalkyl, especially C₁-C₁₈-fluoroalkyl, for example trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylisopentyl, C₆F₁₃, C₈F₁₇, C₁₀F₂₁, C₁₂F₂₅, especially C₁-C₁₈-chloroalkyl such as chloromethyl, 2-chloroethyl, trichloromethyl, 1,1-dimethyl-2-chloroethyl;

amino-C₁-C₁₈-alkyl such as 2-aminoethyl, 2-aminopropyl, 3-aminopropyl, 4-aminobutyl, 6-aminohexyl,

C₁-C₆-alkylamino-C₁-C₁₈-alkyl such as 2-methylaminoethyl, 2-methylaminopropyl, 3-methylaminopropyl, 4-methylaminobutyl, 6-methylaminohexyl;

di(C1-C6-alkyl)-C₁-C₁₈-alkyl such as 2-dimethylaminoethyl, 2-dimethylaminopropyl, 3-dimethylaminopropyl, 4-dimethylaminobutyl, 6-dimethylaminohexyl,

cyano-C₁-C₁₈-alkyl such as 2-cyanoethyl, 2-cyanopropyl,

C₁-C₁₀-alkoxy-C₁-C₁₈-alkyl such as methoxymethyl, 2-methoxyethyl, 2-methoxypropyl, 3-methoxypropyl, 2-methoxyisopropyl, 4-methoxybutyl, 6-methoxyhexyl, 2-ethoxyethyl, 2-ethoxypropyl, 3-ethoxypropyl, 4-ethoxybutyl, 6-ethoxyhexyl, 2-isopropoxyethyl, 2-butoxyethyl, 2-butoxypropyl, 2-octyloxyethyl, 5-methoxy-3-oxa-pentyl, 8-methoxy-3,6-dioxaoctyl, 7-methoxy-4-oxaheptyl, 11-methoxy-4,8-dioxaundecyl, 9-methoxy-5-oxanonyl, 9-methoxy-5-oxanonyl, 14-methoxy-5,10-dioxatetradecyl, 5-ethoxy-3-oxapentyl, 8-ethoxy-3,6-dioxaoctyl, 7-ethoxy-4-oxaheptyl, 11-ethoxy-4,8-dioxaundecyl, 9-ethoxy-5-oxanonyl or 14-ethoxy-5,10-oxatetradecyl, 15-methoxy-4,8,12-trioxapentadecyl, 11-methoxy-3,6,9-trioxaundecyl, 11-ethoxy-3,6,9-trioxaundecyl, 15-ethoxy-4,8,12-trioxapentadecyl;

di(C₁-C₁₀-alkoxy-C₁-C₁₈-alkyl) such as diethoxymethyl or diethoxyethyl,

C₁-C₆-alkoxycarbonyl-C₁-C₁₈-alkyl such as 2-(methoxycarbonyl)ethyl, 2-(ethoxycarbonyl)ethyl, 2-(n-butoxycarbonyl)ethyl,

di(C₁-C₆-alkoxycarbonyl)-C₁-C₁₈-alkyl such as 1,2-di(methoxycarbonyl)ethyl,

hydroxy-C₁-C₁₈-alkyl such as 2-hydroxyethyl, 2-hydroxypropyl, 3-hydroxypropyl, 4-hydroxybutyl, 6-hydroxyhexyl, 2-hydroxy-2,2-dimethylethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl;

C₁-C₁₂-alkylsulfanyl-C₁-C₁₈-alkyl such as butylthiomethyl, 2-dodecylthioethyl,

C₅-C₁₂-cycloalkyl-C₁-C₁₈-alkyl such as cyclopentylmethyl, 2-cyclopentylethyl, 3-cyclopentylpropyl, cyclohexylmethyl, 2-cyclohexylethyl, 3-cyclohexylpropyl, phenyl-C₁-C₁₈-alkyl, where the phenyl part of phenyl-C₁-C₁₈-alkyl is unsubstituted or substituted by one, two, three or four substituents selected independently from among C1-C6-alkyl, halogen, C₁-C₆-alkoxy and nitro, e.g. benzyl (phenylmethyl), 1-phenylethyl, 2-phenylethyl, 3-phenylpropyl, p-tolylmethyl, 1-(p-butylphenyl)ethyl, p-chlorobenzyl, 2,4-dichlorobenzyl, p-methoxybenzyl, m-ethoxybenzyl, phenyl-C(CH₃)₂—, 2,6-dimethylphenylmethyl,

diphenyl-C₁-C₁₈-alkyl such as diphenylmethyl (benzhydryl);

triphenyl-C₁-C₁₈-alkyl such as triphenylmethyl;

phenoxy-C₁-C₁₈-alkyl such as 2-phenoxyethyl, 2-phenoxypropyl, 3-phenoxypropyl, 4-phenoxybutyl, 6-phenoxyhexyl;

phenylthio-C₁-C₁₈-alkyl such as 2-phenylthioethyl.

If R¹ to R⁹ are C₂-C₁₈-alkenyl, then R¹ to R⁹ are preferably each C₂-C₆-alkenyl such as vinyl, 2-propenyl, 3-butenyl, cis-2-butenyl, trans-2-butenyl or C₂-C₁₈-alkenyl which may be partially or completely substituted by fluorine.

If R¹ to R⁹ are C₆-C₁₀-aryl, then R¹ to R⁹ are each preferably phenyl or naphthyl, where phenyl or naphthyl is unsubstituted or substituted by one, two, three or four substituents selected independently from among halogen, C₁-C₁₅-alkyl, C₁-C₆-alkoxy, C₁-C₆-alkylsulfanyl, C₁-C₆-alkoxy-C₁-C₆-alkyl, C₁-C₆-alkylcarbonyl, amino, C₁-C₆-alkylamino, di(C₁-C₆-dialkyl)amino and nitro, e.g. phenyl, methylphenyl (tolyl), dimethylphenyl (xylyl) such as 2,6-dimethylphenyl, trimethylphenyl such as 2,4,6-trimethylphenyl, ethylphenyl, diethylphenyl, isopropylphenyl, tert-butylphenyl, dodecylphenyl, chlorophenyl, dichlorophenyl, trichlorophenyl, fluorophenyl, difluorophenyl, trifluorophenyl, tetrafluorophenyl, pentafluorophenyl, 2,6-dichlorophenyl, 4-bromophenyl, methoxyphenyl, dimethoxyphenyl, ethoxyphenyl, hexyloxyphenyl, 2,6-dimethoxyphenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl, tertbutylthiophenyl, α-naphthyl, β-naphthyl, methylnaphthyl, isopropylnaphthyl, chloronaphthyl, ethoxynaphthyl or partially fluorinated phenyl or perfluorinated phenyl.

If R¹ to R⁹ are C₅-C₁₂-cycloalkyl, then R¹ to R⁹ are preferably each unsubstituted cycloalkyl such as cyclopentyl or cyclohexyl;

C₅-C₁₂-cycloalkyl which is substituted by one or two substituents selected independently from among C₁-C₆-alkyl, C₁-C₆-alkoxy, C₁-C₆-alkylsulfanyl and chlorine, e.g. butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl;

C₅-C₁₂-cycloalkyl which is completely or fully fluorinated.

If R¹ to R⁹ are polycyclyl, then R¹ to R⁹ are each preferably C₅-C₁₂-bicycloalkyl such as norbornyl or C₅-C₁₂-bicycloalkenyl such as norbornenyl.

If R¹ to R⁹ are C₅-C₁₂-cycloalkenyl, then R¹ to R⁹ are each preferably unsubstituted cycloalkenyl such as cyclopent-2-en-1-yl, cyclopent-3-en-1-yl, cyclohex-2-en-1-yl, cyclohex-1-en-1-yl, cyclohexa-2,5-dien-1-yl or partially or completely fluorinated cycloalkenyl.

If R¹ to R⁹ are heterocycloalkyl having 5 or 6 ring atoms, then R¹ to R⁹ are each preferably 1,3-dioxolan-2-yl, 1,3-dioxan-2-yl, 2-methyl-1,3-dioxolan-2-yl, 4-methyl-1,3-dioxolan-2-yl.

If R¹ to R⁹ are heteroaryl, then R¹ to R⁹ are each preferably furyl, thienyl, pyrryl, pyridyl, indolyl, benzoxazolyl, benzimidazolyl, benzothiazolyl. If hetaryl is substituted, it bears 1, 2 or 3 substituents selected independently from among C₁-C₆-alkyl, C₁-C₆-alkoxy and halogen, for example dimethylpyridyl, methylquinolyl, dimethylpyrryl, methoxyfuryl, dimethoxypyridyl or difluoropyridyl. Particular preference is given to the radicals R¹ to R⁹ each being, independently of one another,
hydrogen;
unbranched or branched C₁-C₁₈-alkyl which may be unsubstituted or substituted by one or more hydroxy, halogen, phenyl, cyano, C₁-C₆-alkoxycarbonyl and/or sulfo groups, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, methoxylcarbonylmethyl, ethoxycarbonylmethyl, n-butoxycarbonylmethyl, tert-butoxycarbonylmethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, unundecylfluoropentyl, undecylfluoroisopentyl, 6-hydroxyhexyl and 3-sulfopropyl;
hydroxyethyloxyalkyl, radicals of oligoalkylene and polyalkylene glycols such as polyethylene glycols and polypropylene glycols and their oligomers having from 2 to 100 units and a hydrogen or a C₁-C₈-alkyl as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— where R^{A} and R^{B} are each preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
C₂-C₄-alkenyl such as vinyl and allyl; and
N,N-di-C1-C6-alkylamino such as N,N-dimethylamino and N,N-diethylamino.

Very particular preference is given to the radicals R¹ to R⁹ each being, independently of one another, hydrogen; C₁-C₁₈-alkyl such as methyl, ethyl, 1-butyl, 1-pentyl, 1-hexyl, 1-heptyl, 1-octyl; phenyl; 2-hydroxyethyl; 2-cyanoethyl; 2-(alkoxycarbonyl)ethyl such as 2-(methoxycarbonyl)ethyl, 2-(ethoxycarbonyl)ethyl or 2-(n-butoxycarbonyl)ethyl; N,N-(C₁-C₄-dialkyl)amino such as N,N-dimethylamino or N,N-diethylamino; chlorine or a radical of oligoalkylene glycol, e.g. CH₃O—(CH₂CH₂O)ₙ—CH₂CH₂— or CH₃CH₂O—(CH₂CH₂O)ₙ—CH₂CH₂— where n is from 0 to 3.

In the following described very particularly preferred [A⁺] cations (IVa) to (IVz) the substituent R has the following meaning:
R is a C₁ to C₃₀ organic residue as defined above, which can be preferably selected from residues defined herein under groups (I) to (VIII) above, for example substituted or unsubstituted “alkyl”, “arylalkyl”, “alkenyl”, “cycloalkyl”, “cycloalkenyl”, “polycyclyl”, “aryl”, “aryloxy”, “arylthio”, “heterocycloalkyl”, “heteroarayl”, very preferably a straight chain or branched C₁ to C₃₀ alkyl and most preferably unsubstituted straight chain or branched C₁ to C₃₀ “alkyl” residues as defined in group (I) above, for example methyl, ethyl, propyl, butyl, pentyl, hexyl, heptyl, octyl, nonyl, decyl, undecyl, dodecyl.

Very particularly preferred pyridinium ions (IVa) are those in which

one of the radicals R¹ to R⁵ is methyl, ethyl or chlorine and the remaining radicals R¹ to R⁵ are each hydrogen;

R³ is dimethylamino and the remaining radicals R¹, R², R⁴ and R⁵ are each hydrogen;

all radicals R¹ to R⁵ are hydrogen;

R² is carboxy or carboxamide and the remaining radicals R¹, R², R⁴ and R⁵ are each hydrogen; or

R¹ and R² or R² and R³ are 1,4-buta-1,3-dienylene and the remaining radicals R¹, R³, R⁴ and R⁵ are each hydrogen;

and in particular those in which

R¹ to R⁵ are each hydrogen; or

one of the radicals R¹ to R⁵ is methyl or ethyl and the remaining radicals R¹ to R⁵ are each hydrogen.

Particularly preferred pyridinium ions (IVa) are pyridinium, 2-methylpyridinium, 2-ethylpyridinium, 5-ethyl-2-methylpyridinium and 2-methyl-3-ethylpyridinium and also 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, t-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 9-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethyl-pyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

Particularly preferred pyridazinium ions (IVb) are those in which

the radicals R¹ to R⁴ are each hydrogen or

one of the radicals R¹ to R⁴ is methyl or ethyl and the remaining radicals R¹ to R⁴ are each hydrogen.

Particularly preferred pyrimidinium ions (IVc) are those in which

R¹ is hydrogen, methyl or ethyl and R² to R⁴ are each, independently of one another, hydrogen or methyl, or

R¹ is hydrogen, methyl or ethyl and R² and R⁴ are each methyl and R³ is hydrogen.

Particularly preferred pyrazinium ions (IVd) are those in which

R¹ is hydrogen, methyl or ethyl and R² to R⁴ are each, independently of one another, hydrogen or methyl, or

R¹ is hydrogen, methyl or ethyl and R² and R⁴ are each methyl and R³ is hydrogen, or

R¹ to R⁴ are each methyl or

R¹ to R⁴ are each hydrogen.

Particularly preferred imidazolium ions (IVe) are those in which

R¹ is hydrogen, methyl, ethyl, 1-propyl, 1-butyl, 1-pentyl, 1-hexyl, 1-octyl, dodecyl, 2-hydroxyethyl or 2-cyanoethyl and R² to R⁴ are each, independently of one another, hydrogen, methyl or ethyl.

Particularly useful imidazolium ions (IVe) are 1-methylimidazolium, 1-ethylimidazolium, 1-(1-propyl)imidazolium, 1-(1-butyl)imidazolium, 1-(1-octylimidazolium, 1-(1-dodecyl)imidazolium, 1-(1-tetradecyl)imidazolium, 1-(1-hexadecyl)imidazolium, 1,3-dimethylimidazolium, 1,3-diethylimidazolium, 1-ethyl-3-methylinnidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazoliunn, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-methylimidazolium, 3-ethylimidazolium, 3-n-propylimidazolium, 3-n-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium, 1-(prop-1-en-3-yl)-3-methylimidazolium and 1-(prop-1-en-3-yl)-3-butylimidazolium. Especially suitable imidazolium ions (IVe) are 1,3-diethylimidazolium, 1-ethyl-3-methylimidazolium, 1-(n-butyl)-3-methylimidazolium.

Particularly preferred pyrazolium ions (IVf), (IVg) and (IVg′) are those in which

R¹ is hydrogen, methyl or ethyl and R² to R⁴ are each, independently of one another, hydrogen or methyl.

Particularly preferred pyrazolium ions (IVh) are those in which

R¹ to R⁴ are each, independently of one another, hydrogen or methyl.

As particularly preferred pyrazolium ions, mention may be made of pyrazolium and 1,4-dimethylpyrazolium.

1-Pyrazolinium ions (IVi) used in the process of the invention are particularly preferably those in which

R¹ to R⁶ are each, independently of one another, hydrogen or methyl.

Particularly preferred 2-pyrazolinium ions (IVj) and (IVj′) are those in which R¹ is hydrogen, methyl, ethyl or phenyl and R² to R⁶ are each, independently of one another, hydrogen or methyl.

Particularly preferred 3-pyrazolinium ions (IVk) and (IVic′) are those in which

R¹ and R² are each, independently of one another, hydrogen, methyl, ethyl or phenyl and R³ to R⁶ are each, independently of one another, hydrogen or methyl.

Particularly preferred imidazolinium ions (IV I) are those in which

R¹ and R² are each, independently of one another, hydrogen, methyl, ethyl, 1-butyl or phenyl and R³ and R⁴ are each, independently of one another, hydrogen, methyl or ethyl and R⁵ and R⁶ are each, independently of one another, hydrogen or methyl.

Particularly preferred imidazolinium ions (IVm) and (IVm′) are those in which

R¹ and R² are each, independently of one another, hydrogen, methyl or ethyl and R³ to R⁶ are each, independently of one another, hydrogen or methyl.

Particularly preferred imidazolinium ions (IVn) and (IVn′) are those in which

R¹ to R³ are each, independently of one another, hydrogen, methyl or ethyl and R⁴ to R⁶ are each, independently of one another, hydrogen or methyl.

Particularly preferred thiazolium ions (IVo) and (IVo′) and oxazolium ions (IVp) are those in which

R¹ is hydrogen, methyl, ethyl or phenyl and R² and R³ are each, independently of one another, hydrogen or methyl.

1,2,4-Triazolium ions (IVq), (IVq′) and (IVq″) used in the process of the invention are particularly preferably those in which

R¹ and R² are each, independently of one another, hydrogen, methyl, ethyl or phenyl and R³ is hydrogen, methyl or phenyl.

Particularly preferred 1,2,3-triazolium ions (IVr), (IVr ) and (IVr″) are those in which

R¹ is hydrogen, methyl or ethyl, R² and R³ are each, independently of one another, hydrogen or methyl or R² and R³ are together 1,4-buta-1,3-dienylene.

Particularly preferred pyrrolidinium ions (IVs) are those in which

R¹ is hydrogen, methyl, ethyl, butyl or phenyl and R² to R⁹ are each, independently of one another, hydrogen or methyl.

Particularly preferred imidazolidinium ions (IVt) are those in which

R¹ and R⁴ are each, independently of one another, hydrogen, methyl, ethyl or phenyl and R², R³ and R⁵ to R⁸ are each, independently of one another, hydrogen or methyl.

Particularly preferred guanidinium ions (IVv) are those in which

R¹ to R⁵ are methyl, ethyl or butyl. As very particularly preferred guanidinium ions (IVv), mention may be made of N,N,N′,N′-tetrabutyl-N″,N′-′dimethylguanidinium, N,N,N″,N″,N″-Pentabutyl-N″-methylguanidinium, N,N,N″,N″-Tetrabutyl-N″-ethyl-N″-methylguanidinium.

Particularly preferred cholinium ions (IVw) are those in which

R¹ and R² are each, independently of one another, methyl, ethyl, 1-butyl or 1-octyl and R³ is hydrogen, methyl, ethyl, acetyl, —SO₂OH or —PO(OH)₂, or

R¹ is methyl, ethyl, 1-butyl or 1-octyl, R² is a —CH₂—CH₂—OR⁴ group and R³ and R⁴ are each, independently of one another, hydrogen, methyl, ethyl, acetyl, —SO₂OH or —PO(OH)₂, or

R¹ is a —CH₂—CH₂—OR⁴ group, R² is a —CH₂—CH₂—OR⁵ group and R³ to R⁵ are each, independently of one another, hydrogen, methyl, ethyl, acetyl, —SO₂₀H or —PO(OH)₂.

As cholinium ions (IVw), particular preference is given to those in which R³ is selected from among hydrogen, methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

The cations (IV.x.1) are particularly preferably selected from among cations of 1,5-diazabicyclo[4.3.0]non-5-ene (DBN) and 1,8-diazabicyclo[5.4.0]undec-7-ene (DBU).

Particularly preferred phosphonium ions (IVy) are those in which

R¹ to R³ are each, independently of one another, C₁-C₁₈-alkyl, in particular methyl, butyl, isobutyl, 1-hexyl or 1-octyl, or phenyl which is unsubstituted or bears 1, 2, 3, 4 or 5 substituents selected independently from among C₁-C₁₈-alkyl, carboxylate, sulfonate, COOH and SO₃H.

Particularly preferred sulfonium ions (IVz) are those in which

R¹ and R² are each, independently of one another, C₁-C₁₈-alkyl, in particular butyl, isobutyl, 1-hexyl or 1-octyl.

Among the abovementioned heterocyclic cations, the imidazolium ions, imidazolinium ions, pyrrolidinium ions, guanidinium ions and phosphonium ions are preferred.

Particular preference is given to the imidazolium ions.

Very preferably [A]⁺ cations are selected amongst the following groups (i) to (iv):

In the following described very preferred [A⁺] cations (i) to (iv) the substituent R has the following meaning:
R is a C₁ to C₃₀ organic residue as defined above, which can be preferably selected from residues defined herein under groups (I) to (VIII) above, for example substituted or unsubstituted “alkyl”, “arylalkyl”, “alkenyl”, “cycloalkyl”, “cycloalkenyl”, “polycyclyl”, “aryl”, “aryloxy”, “arylthio”, “heterocycloalkyl”, “heteroarayl”, very preferably a straight chain or branched C₁ to C₃₀ alkyl and most preferably unsubstituted straight chain or branched C₁ to C₃₀ “alkyl” residues as defined in group (I) above, for example methyl, ethyl, propyl, butyl, pentyl, hexyl, heptyl, octyl, nonyl, decyl, undecyl, dodecyl.

(i) imidazolium ions (IVe) in which

R¹ is hydrogen, methyl, ethyl, 1-propyl, 1-butyl, 1-pentyl, 1-hexyl, 1-octyl, dodecyl, 2-hydroxyethyl or 2-cyanoethyl and R² to R⁴ are each, independently of one another, hydrogen, methyl or ethyl.

Particularly useful imidazolium ions (IVe) are 1-methylimidazolium, 1-ethylimidazolium, 1-(1-propyl)imidazolium, 1-(1-allyl)imidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1,3-diethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-methylimidazolium, 3-ethylimidazolium, 3-n-propylimidazolium, 3-n-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium, 1-(prop-1-en-3-yl)-3-methylimidazolium and 1-(prop-1-en-3-yl)-3-butylimidazolium. Especially suitable imidazolium ions (IVe) are 1,3-diethylimidazolium, 1-ethyl-3-methylimidazolium, 1-(n-butyl)-3-methylimidazolium.

(ii) pyrrolidinium ions (IVs) in which

R¹ is hydrogen, methyl, ethyl, butyl or phenyl and R² to R⁹ are each, independently of one another, hydrogen or methyl.

(iii) guanidinium ions (IVv) in which

R¹ to R⁵ are methyl, ethyl or butyl. As very particularly preferred guanidinium ions (IVv), mention may be made of N,N,N′,N′-tetrabutyl-N″,N′-′dimethylguanidinium, Pentabutyl-N″-methylguanidinium, N,N,N″,N″-Tetrabutyl-N″-ethyl-N″-methylguanidinium

(iv) phosphonium ions (IVy) in which

R¹ to R³ are each, independently of one another, C₁-C₁₈-alkyl, in particular methyl, butyl, isobutyl, 1-hexyl or 1-octyl, or phenyl which is unsubstituted or bears 1, 2, 3, 4 or 5 substituents selected independently from among C₁-C₁₈-alkyl, carboxylate, sulfonate, COOH and SO₃H.

X is in general formula (I) a C₁ to C₃₀ organic residue as defined above, which can be preferably selected from residues defined herein under (I) to (X) above, for example substituted or unsubstituted “alkyl”, “alkyl”, “arylalkyl”, “alkenyl”, “cycloalkyl”, “cycloalkenyl”, “polycyclyl”, “aryl”, “aryloxy”, “arylthio”, “heterocycloalkyl”, “heteroarayl”, all as defined herein, most preferably a straight chain or branched C₁ to C₃₀ alkyl; examples of the alkyl are given herein under the definition of “alkyl” in (I).

Examples for suitable monosubstituted oxalic acid derivatives of the general formula (I) are those wherein A is selected from the group consisting of the above defined compounds IV.a to IV.z and X is selected from the group consisting of straight chain or branched C₁-C₃₀ alkyl.

Examples for very suitable monosubstituted oxalic acid derivatives of the general formula (I) are those wherein A is selected from the group consisting of the above defined compounds IV.e (imidazolium), IVs (pyrrolidinium), IVv (guanidinium), IVy (phosphonium) and X is selected from the group consisting of unsubstituted straight chain or branched C₁ to C₃₀ alkyl residues, preferably as defined in group (I) above, for example methyl, ethyl, propyl, butyl, pentyl, hexyl, heptyl, octyl, nonyl, decyl, undecyl, dodecyl.

Examples for preferred monosubstituted oxalic acid derivatives of the general formula (I) are those, wherein A is selected from the group consisting of the above described compounds IV.e (imidazolium) and X is selected from the group consisting of unsubstituted straight chain or branched C₁ to C₃₀ alkyl residues, preferably as defined in group (I) above, for example methyl, ethyl, propyl, butyl, pentyl, hexyl, heptyl, octyl, nonyl, decyl, undecyl, dodecyl.

Monosubstituted oxalic acid derivatives of the general formula (I) are preferably in the state of an ionic liquid.

For the purpose of the resent patent application ionic liquids are organic salts which are liquid at temperatures below 180° C., preferably below 130° C., very preferably below 75° C., most preferably below 25° C.

In general the melting points of the oxalic acid derivatives of the general formula (I) are in a range of from −50° C. to 180° C., more preferably in the range of from −20° C. to 130° C.

The oxalic acid derivatives of the general formula (I) are prepared by the reaction of an oxalic acid compound of the general formula (II)

R¹O—C(O)—C(O)—O—X (II)

with the organic moiety A as defined above (including all modes), however wherein the heteroatom in the precursor is not yet formally positively charged.

R¹ has the meaning of R as defined above, including all modes. R¹ and X can be the same or different. Preferably at least one of R¹ and X is a straight chain or branched C₁ to C₃₀ alkyl and most preferably unsubstituted straight chain or branched C₁ to C₃₀ “alkyl” residues as defined in group (I) above, for example methyl, ethyl, propyl, butyl, pentyl, hexyl, heptyl, octyl, nonyl, decyl, undecyl, dodecylvery preferably at least one of R¹ and X is methyl, ethyl, propyl, butyl, dodecyl most preferably at least one of R¹ and X is methyl, ethyl, propyl, in particular R¹ and X are methyl.

Examples for oxalic acid derivatives of the general formula (II) are described in the section “Examples” of this application.

The monosubstituted oxalic acid derivatives of the general formula (I) (without disclaimer), preferably those which are in the state of an ionic liquid, can be used to at least partially dissolve inorganic or organic material, for example metal compounds such as compounds of rare earth elements or actinide elements.

The monosubstituted oxalic acid derivatives of the general formula (I) (without disclaimer), preferably those which are in the state of an ionic liquid, can be used in a separation process for metals, in a separation process for rare earth elements and actinide elements, for example in liquid-liquid extraction processes for the separation of metals for example the separation of rare earth elements from each other.

### EXAMPLES

### A) Synthesis of Ionic Monosubstituted Oxalic Acid Derivatives

### Example 1

### N,N,N′,N″,N″-Pentabutyl-N″-methylguanidinium-methyloxalate

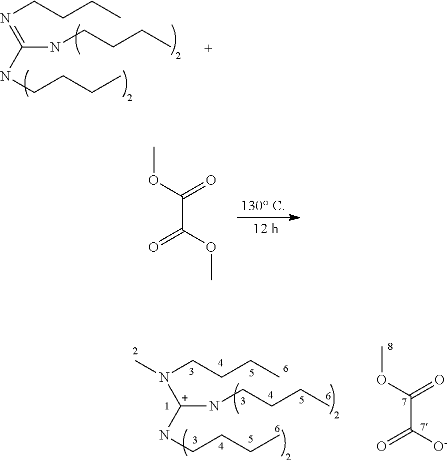

17.12 g (50.6 mmol) of N,N,N″,N″,N″-pentabutylguanidine and 8.75 g (74.2 mmol) dimethyloxalate were stirred for 12 hours at 130° C. The mixture was washed with hexanes and dried in vacuo. 20.9 g (45.6 mmol, 90%) of a brown oily liquid were obtained.

¹H-NMR (CD₃CN, 300 MHz): δ=3.24 (s, 3H, H_{C8}), 3.23-2.90 (m, 10H, H_{C3}), 2.86 (s, 3H, H_{C2}), 1.77-1.13 (m, 20H, H_{C4,5}), 0.87 (t, 15H, ³J_{HH}=7.2 Hz, H_{C6}) ppm.

¹³C-NMR (CD3CN, 75 MHz): δ=164.9 (C1,7′), 157.4 (C7), 53.5 (C8), 51.7, 50.5, 50.1, 50.1, 49.7 (C3), 38.7 (C2), 30.4, 30.3, 30.2, 30.1, 30.0 (C4), 20.7 (C5), 14.0 (C6) ppm.

IR: \tilde{v}=2956 (m), 2931 (m), 2871 (m), 1677 (s), 1535 (s), 1457 (m), 1433 (m), 1378 (w), 1314 (w), 1270 (s), 1174 (w), 1110 (w), 1066 (s), 940 (w), 891 (w), 843 (m), 739 (w) cm⁻¹.

Elemental analyses: C₂₆H₅₁N₃O₄ (457.69 g/mol) calculated: C, 65.60%; H, 11.23%; N, 9.18%. found: C, 64.61%; H, 11.83%; N, 10.39%.

### Example 2

### N,N,N″,N″-Tetrabutyl-N″-ethyl-N″-methylguanidinium-methyloxalate

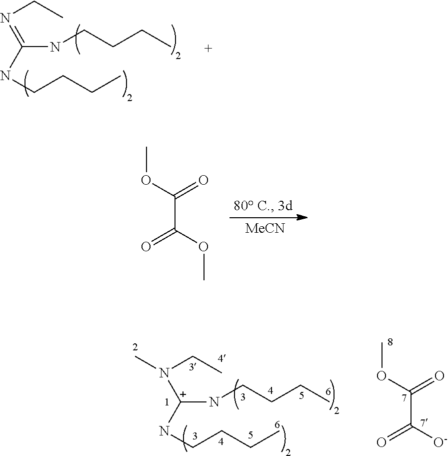

0.40 g (1.27 mmol) N,N,N″,N″-tetrabutyl-N″-ethylguanidine and 0.25 g (2.13 mmol) dimethyloxalate in 0.5 ml acetonitrile were stirred for three days at 80° C. The mixture was dried in vacuo, dissolved in a mixture of acetonitrile and diethylether (1:1), washed three times with hexanes and dried in vacuo. 0.54 g (1.26 mmol, 99%) of a yellow oily liquid were obtained.

¹H-NMR (CD₃CN, 300 MHz): δ=3.53 (s, 3H, H_{C8}), 3.32-2.90 (m, 10H, H_{C3,3′}), 2.85 (s, 3H, H_{C2}), 1.75-1.20 (m, 16H, H_{C4,5}), 1.16 (t, 3H, ³J_{HH}=7.2 Hz, H_{C4′}), 0.88 (2xt, 12H, ³J_{HH}=7.3 Hz, H_{C6}) ppm.

¹³C-NMR (CD₃CN, 75 MHz): δ=169.3 (C7′), 164.7 (C1), 164.0 (C7), 50.5 (C8), 50.4, 50.2, 50.0, 49.7 (C3′), 48.4 (C8), 37.9 (C2), 30.4, 30.2, 30.1, 30.0 (C4), 20.66, 20.58, 20.6 (C5), 14.0 (04′), 13.0 (C6) ppm.

IR: \tilde{v}=2956 (m), 2932 (m), 2871 (m), 1716 (m), 1636 (s), 1537 (s), 1457 (m), 1363 (m), 1323 (w), 1186 (m), 1158 (s), 1112 (w), 1094 (w), 1058 (w), 991 (w), 943 (w), 894 (w), 853 (w), 805 (w), 752 (m) cm⁻¹.

Elemental analyses: C₂₃H₄₇N₃O₄ (429.64 g/mol) calculated: C, 64.30%; H, 11.03%; N, 9.78%. found: C, 63.17%; H, 10.94%; N, 10.11%.

### Example 3

### N,N,N″,N″-Tetrabutyl-N″,N″-dimethylguanidinium-methyloxalate

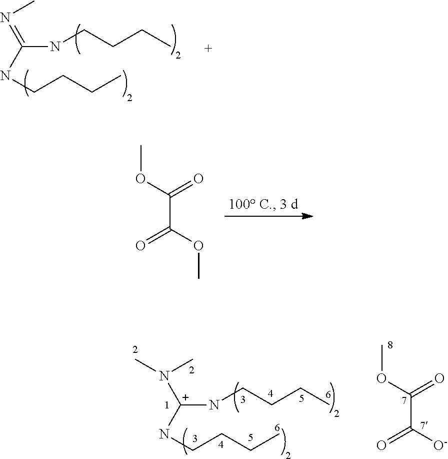

0.43 g (1.46 mmol) N,N,N″,N″-tetrabutyl-N″-methylguanidine and 0.38 g (3.23 mmol) dimethyloxalate were stirred for three days at 100° C. The mixture was washed with hexanes and dried in vacuo. 0.52 g (1.26 mmol, 86%) of a brown oil were obtained.

¹H-NMR (CD₃CN, 300 MHz): δ=3.55 (s, 3H, H_{C8}), 3.28-2.95 (m, 8H, H_{C3}), 2.86 (s, 6H, H_{C2}), 1.75-1.19 (m, 16H, H_{C4,5}), 0.90 (t, 12H, ³J_{HH}=7.2 Hz, H_{C6}) ppm.

¹³C-NMR (CD3CN, 75 MHz): δ=169.1 (C7′), 164.5 (C1), 164.0 (C7), 54.1 (C8), 50.5, 49.7 (C3), 40.8 (C2), 30.4, 30.1 (C4), 20.7, 20.6 (C5), 13.9 (C6) ppm.

IR: \tilde{v}=2956 (m), 2932 (m), 2871 (m), 1770 (w), 1715 (m), 1635 (s), 1578 (m), 1537 (s), 1458 (m), 1418 (m), 1364 (m), 1317 (w), 1249 (w), 1216 (m), 1185 (w), 1157 (s), 1112 (w), 1062 (w), 991 (w), 940 (w), 891 (w), 852 (w), 800 (w), 752 (m)

Elemental analyses: C₂₂H₄₅N₃O₄ (415.61 g/mol) calculated: C, 63.58%; H, 10.91%; N, 10.11%. found: C, 61.16%; H, 11.26%; N, 9.57%.

### Example 4

### N,N′-Dimethylimidazolium-methyloxalate

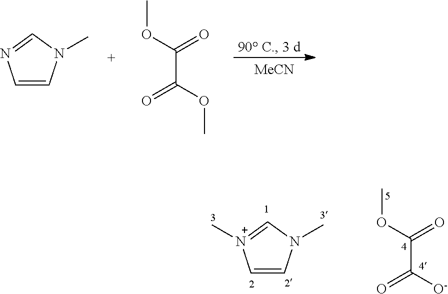

1.96 g (23.91 mmol) N-methylimidazole and 3.03 g (25.62 mmol) dimethyloxalate in 0.5 mL acetonitrile were stirred for three days at 90° C. The mixture was washed with hexanes and dried in vacuo. 4.68 g (23.43 mmol, 98%) of a yellow liquid were obtained.

¹H-NMR (CD₃CN, 300 MHz): δ=9.62 (s, 1H, H_{C1}), 7.61 (d, 2H, ⁴J_{HH}=1.6 Hz, H_{C2,2′}), 3.83 (s, 3H, H_{C3}), 3.83 (s, 3H, H_{C3′}), 3.53 (s, 3H, H_{C4}) ppm.

¹³C-NMR (CD₃CN, 75 MHz): δ=169.6 (C4′), 164.9 (C4), 140.0 (C1), 125.2 (C2,2′), 51.8 (C5), 37.1 (C3,3′) ppm.

IR: \tilde{v}=3076 (w), 2952 (w), 2858 (w), 1713 (m), 1627 (s), 1573 (m), 1455 (w), 1371 (m), 1196 (m), 1170 (s), 1089 (w), 977 (w), 858 (w), 755 (m), 715 (w), 625 (w) cm⁻¹.

Elemental analyses: C₈H₁₂N₂O₄ (200.19 g/mol) calculated: C, 48.00%; H, 6.04%; N, 13.99%. found: C, 47.21%; H, 6.48%; N, 14.06%.

### Example 5

### N-Butyl-N′-methylimidazolium-methyloxalate

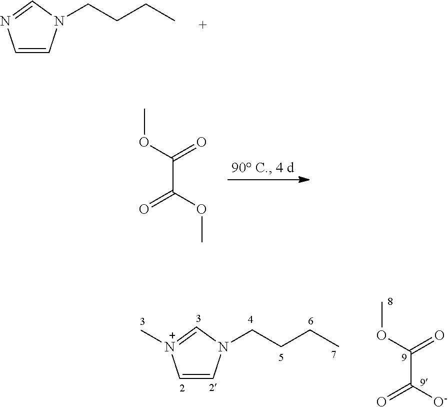

1.28 g (10.31 mmol) N-butylimidazole and 3.69 g (30.92 mmol) dimethyloxalate were stirred for four days at 90° C. The mixture was washed with hexanes and dried in vacuo. 2.40 g (9.93 mmol, 96%) of a yellow oil were obtained.

¹H-NMR (CD₃CN, 300 MHz): δ=9.78 (s, 1H, H_{C1}), 7.65 (2xt, 2H, ⁴J_{HH}=1.5 Hz, H_{C2,2′}), 4.17 (t, 2H, ³J_{HH}=7.2 Hz, H_{C4}), 3.85 (s, 3H, H_{C3}), 3.54 (s, 3H, H_{C8}), 1.80-1.67 (m, 2H, H_{C5}), 1.28-1.13 (m, 2H, H_{C6}), 0.89 (t, 3H, ³J_{HH}=7.4 Hz, H_{C7}) ppm.

¹³C-NMR (CD₃CN, 75 MHz): δ=168.8 (C9′), 164.2 (C9), 138.8 (C1), 124.6 (C2), 123.3 (C2′), 51.0 (C8), 49.8 (C3), 36.4 (C4), 32.7 (C5), 19.9 (C6), 13.8 (C7) ppm.

IR: \tilde{v}=2958 (w), 2873 (w), 1715 (m), 1628 (s), 1568 (m), 1461 (w), 1370 (m), 1195 (m), 1168 (s), 980 (w), 858 (w), 755 (m), 654 (w), 625 (w), 409 (w) cm⁻¹.

Elemental analyses: C₁₁H₁₈N₂O₄ (242.27 g/mol) calculated: C, 54.53%; H, 7.49%; N, 11.56%. found: C, 54.50%; H, 8.08%; N, 12.95%.

### Example 6

### N-Dodecyl-N′-methylimidazolium-methyloxalate

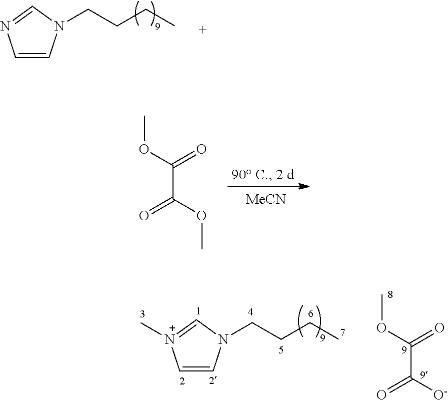

1.65 g (6.96 mmol) N-Dodecylimidazole and 2.50 g (21.14 mmol) dimethyloxalate in 5 mL acetonitrile were stirred for two days at 90° C. The mixture was washed with hexanes and dried in vacuo. 2.30 g (6.46 mmol, 93%) of a colorless solid were obtained.

¹H-NMR (CD₃CN, 300 MHz): δ=9.55 (s, 1H, H_{C1}), 7.47 (2×t, 2H, ⁴J_{HH}=1.8 Hz, H_{C2,2′}), 4.16 (t, 2H, ³J_{HH}=7.3 Hz, H_{C4}), 3.87 (s, 3H, H_{C3}), 3.59 (s, 3H, H_{C8}), 1.87-1.74 (m, 2H, H_{C5}), 1.34-1.22 (m, 18H, H_{C6}), 0.86 (t, 3H, ³J_{HH}=6.7 Hz, H_{C7}) ppm.

¹³C-NMR (CD₃CN, 75 MHz): δ=168.7 (C9′), 164.1 (C9), 138.5 (C1), 124.4 (C2), 123.1 (CZ), 50.9 (C8), 50.2 (C4), 36.6 (C3), 32.6 (C5), 30.7, 30.3, 30.2, 30.1, 30.0, 29.6, 26.7, 23.3 (C6), 14.3 (C7) ppm.

IR: \tilde{v}=3059 (w), 2916 (m), 2850 (w), 1711 (m), 1630 (s), 1567 (w), 1467 (w), 1470 (w), 1401 (m), 1194 (m), 1165 (s), 1088 (w), 1018 (w), 990 (w), 876 (w), 856 (w), 814 (w), 753 (m), 657 (w), 628 (w) cm⁻¹.

Elemental analyses: C₁₉H₃₄N₂O₄ (355.49 g/mol) calculated: C, 64.38%; H, 9.67%; N, 7.90%. found: C, 64.15%; H, 9.91%; N, 7.84%.

### Example 7

### N,N-Dimethylamino-N′-methylpyridinium-methyloxalate

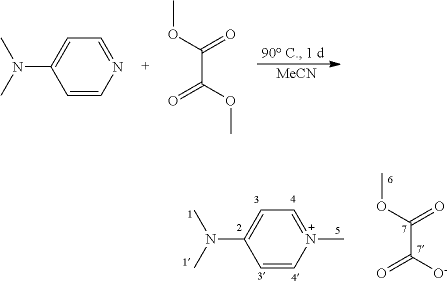

1.01 g (8.20 mmol) N,N-Dimethylaminopyridine and 1.26 g (10.7 mmol) dimethyloxalate in 1 mL acetonitrile were stirred for one day at 90° C. The mixture was added dropwise to hexanes and diethylether was added until a oily phase formed. The oil was separated, washed with hexanes and evaporated in vacuo. 1.84 g (7.67 mmol, 94%) of a yellow brownish solid were obtained. The melting point is below 100° C.

1H-NMR (CD3CN, 300 MHz): δ=8.20 (d, 2H, 3JHH=7.8 Hz, HC4,4′), 6.88 (d, 2H, 3JHH=7.8 Hz, HC3,3′), 3.90 (s, 3H, HC5), 3.55 (s, 3H, HC6), 3.12 (s, 6H, HC1,1′) ppm.

13C-NMR (CD3CN, 75 MHz): δ=168.7 (CT), 164.1 (C7), 157.0 (C2), 144.0 (C4,4′), 108.4 (C3,3′), 50.9 (C6), 44.9 (C5), 40.4 (C1,1′) ppm.

IR: \tilde{v}=2998 (w), 2880 (w), 1710 (m), 1623 (s), 1563 (s), 1540 (m), 1507 (w), 1440 (w), 1386 (m), 1369 (m), 1241 (w), 1190 (s), 1164 (s), 1063 (w), 1028 (w), 965 (m), 943 (m), 860 (m), 840 (m), 805 (w), 751 (s), 639 (w), 614 (w), 506 (m) cm⁻¹.

### Example 8

### N-Butyl-N-methylpyrrolidinium-methyloxalate

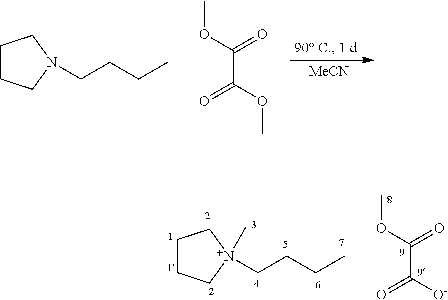

3.88 g (30.5 mmol) N-Butylpyrrolidine and 5.40 g (45.7 mmol) dimethyloxalate in 5 mL acetonitrile were stirred for one day at 90° C. The mixture was washed with hexanes/diethyhether (10:1) and dried in vacuo. 7.14 g (29.12 mmol, 95%) of a golden colored oil were obtained.

¹H-NMR (CD₃CN, 300 MHz): δ=3.56 (s, 3H, H_{C8}), 3.55-3.42 (m, 4H, H_{C2,2′}), 3.37-3.29 (m, 2H, H_{C4}), 3.00 (s, 3H, H_{C3}), 2.17-2.05 (m, 4H, H_{C1,C1′}), 1.75-1.61 (m, 2H, H_{C5}), 1.39-1.24 (m, 2H, H_{C6}), 0.91 (t, 3H, ³J_{HH}=7.3 Hz, H_{C7}) ppm.

¹³C-NMR (CD₃CN, 75 MHz): δ=168.8 (C9′), 164.1 (C9), 64.8 (C2,2′), 64.5 (C4), 50.8 (C8), 48.7 (C3), 26.2 (C5), 22.2 (C1,1′), 20.4 (C6), 13.8 (C7) ppm.

IR: \tilde{v}=2960 (m), 2876 (w), 1712 (s), 1629 (s), 1464 (m), 1369 (m), 1192 (s), 1165 (s), 1063 (w), 980 (m), 930 (m), 857 (w), 806 (w), 754 (s) cm⁻¹.

### Example 9

### Tributylmethylphosphonium-methyloxalate

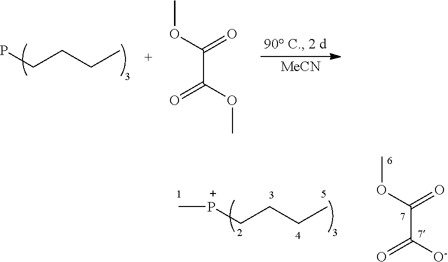

0.92 g (4.53 mmol) tributylphosphine and 0.71 g (6.05 mmol) dimethyloxalate in 2.5 mL acetonitrile were stirred for two days at 90° C. The mixture was washed with hexanes and dried in vacuo. 1.42 g (4.43 mmol, 98%) of a colorless oil were obtained.

¹H-NMR (CD₃CN, 300 MHz): δ=3.55 (s, 3H, H_{C6}), 2.27-2.11 (m, 6H, H_{C2}), 1.79 (d, 3H, ²J_{PH}=13.9 Hz, H_{C1}), 1.60-1.29 (m, 12H, H_{C3,4}), 0.89 (t, 9H, ³J_{HH}=7.1 Hz, H_{C5}) ppm.

¹³C-NMR (CD₃CN, 75 MHz): δ=169.2 (CT), 164.0 (C7), 50.6 (C6), 24.5 (d, ³J_{CP}=15.9 Hz, C4), 23.9 (d, ²J_{CP}32 4.5 Hz, C3), 20.3 (d, ¹J_{CP}=49.5 Hz, C2), 13.7 (C5), 4.1 (d, ¹J_{CP}=52.3 Hz, C1) ppm.

³¹P-NMR (CD₃CN, 122 MHz): δ=31.59 (s) ppm.

IR: \tilde{v}=2958 (m), 2932 (m), 2872 (w), 1716 (m), 1630 (s), 1463 (w), 1367 (m), 1310 (w), 1189 (m), 1162 (s), 1098 (w), 987 (w), 941 (m), 856 (w), 817 (w), 753 (m), 722 (w) cm⁻¹.

Elemental analyses: C₁₆H₃₃O₄P (320.40 g/mol) calculated: C, 59.98%; H, 10.38%. found: C, 59.99%; H, 11.60%.

### Example 9a

### Tributylmethylphosphonium-2-ethyl-hexyloxalate

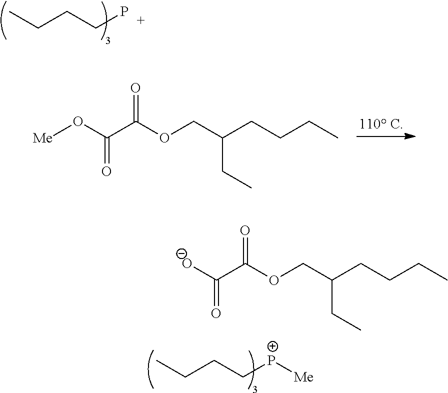

1.31 g (6.06 mmol, 1.00 eq) 2-Ethyl-hexylmethyloxalate and 2.05 g (10.13 mmol, 1.67 eq) Tributylphosphin were heated for 65 h to 110° C. The brownish reaction mixture was dried at low pressure (3·10⁻⁵ mbar, 90° C., 1.5 h). Yield: 1.97 g (4.72 mmol, 78%) of a brown oily product.

¹H-NMR (300 MHz, MeCN-d³): δ/ppm=3.93-3.85 (m, 2H, COOCH₂CH(CH₂CH₃)(CH₂)₃CH₃), 2.27-2.11 (m, 6H, H₃CP(CH₂(CH₂)₂CH₃)₃), 1.80 (d, 3H, ²J_{PH}=13.9 Hz, H₃CP(CH₂(CH₂)₂CH₃)₃), 1.63-1.21 (m, 21H, COOCH₂CH(CH₂CH₃)(CH₂)₃CH₃, H₃CP(CH₂(CH₂)₂CH₃)₃), 0.97-0.82 (m, 15H, COOCH₂CH(CH₂CH₃)(CH₂)₃CH₃, H₃CP(CH₂(CH₂)₂CH₃)₃).

¹³C-NMR (75 MHz, MeCN-d³): δ/ppm=169.0 (COO⁻), 164.4 (COOCH₂CH(CH₂CH₃)(CH₂)₃CH₃), 65.7 (COOCH₂CH(CH₂CH₃)(CH₂)₃CH₃), 39.7 (COOCH₂CH(CH₂CH₃)(CH₂)₃CH₃), 31.0 (COOCH₂CH(CH₂CH₃)(CH₂)₃CH₃), 29.6 (COOCH₂CH(CH₂CH₃)CH₂(CH₂)₂CH₃), 24.5 (d, ³J_{PC}=16.0 Hz, H₃CP((CH₂)₂CH₂CH₃)₃), 24.4 (COOCH₂CH(CH₂CH₃)CH₂CH₂CH₂CH₃), 23.9 (d, ²J_{PC}=4.5 Hz, H₃CP(CH₂CH₂CH₂CH₃)₃), 23.7 (COOCH₂CH(CH₂CH₃)(CH₂)₂CH₂CH₃), 20.2 (d, ¹J_{PC}=49.4 Hz, H₃CP(CH₂(CH₂)₂CH₃)₃), 14.4 (COOCH₂CH(CH₂CH₃)(CH₂)₃CH₃), 13.7 (H₃CP(CH₂(CH₂)₂CH₃)₃), 11.3 (COOCH₂CH(CH₂CH₃)(CH₂)₃CH₃), 4.1 (d, ¹J_{PC}=52.2 Hz, H₃CP(CH₂(CH₂)₂CH₃)₃).

³¹P-NMR (122 MHz, MeCN-d³): δ/ppm=33.86 (s).

ESI-MS (MeOH): pos.: m/z (%)=217.3 (100) [C₁₃H₃₀P]⁺. neg.: m/z (%)=201.2 (100) [C₁₀H₁₇O_{4]}⁻.

HR-MS (MeOH): pos.: m/z=gef. 217.2080, ber. 217.2082 [C₁₃H₃₀P]⁺. neg.: m/z=gef.201.1132, ber. 201.1134 [C₁₀H₁₇O_{4]}⁻.

### Example 10

### N-Butyl-N-methylpyrrolidinium-dodecyloxalate

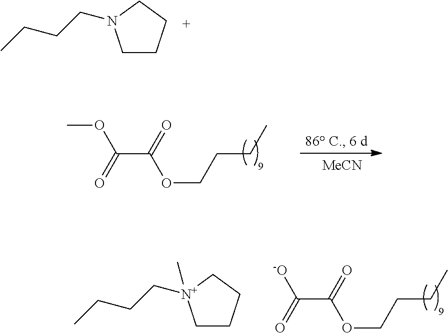

N-Butylpyrrolidine (0.34 g, 2.66 mmol) and dodecylmethyloxalate (0.62 g, 2.42 mmol) in 3 mL of acetonitrile were stirred for six days at 86° C., washed with hexanes and dried in vacuo. 0.69 g (74%) of a yellow solid were obtained. The melting point is below 100° C.

¹H-NMR (300 MHz, MeCN-d³): δ/ppm=0.85 (t, 3H, ³J_{HH}=6.7 Hz, (CH₂)₁₁CH₃), 0.92 (t, 3H, ³J_{HH}=7.3 Hz, N(CH₂)₃CH₃), 1.16-1.39 (m, 20H, N(CH₂)₂CH₂CH₃, O(CH₂)₂(CH₂)₉CH₃), 1.51-1.63 (m, 2H, OCH₂CH₂), 1.63-1.76 (m, 2H, NCH₂CH₂CH₂CH₃), 2.05-2.18 (m, 4H, NCH₂(CH₂)₂CH₂N), 3.01 (s, 3H, NCH₃), 3.30-3.42 (m, 2H, NCH₂(CH₂)₂CH₃), 3.46-3.58 (m, 4H, NCH₂(CH₂)₂CH₂N), 3.96 (t, 2H, ³J_{HH}=6.8 Hz, OCH₂).

¹³C-NMR (75 MHz, MeCN-d³): δ/ppm=13.9 (N(CH₂)₃CH₃), 14.5 (O(CH₂)₁₁CH₃), 20.5 (N(CH₂)₂CH₂CH₃), 22.3 (NCH₂(CH₂)₂CH₂N), 23.4 (OCH₂(CH₂)₁₀CH₃), 26.3 (NCH₂CH₂CH₂CH₃), 26.8, 29.6, 30.1, 30.3, 30.4, 30.4, 32.7 (OCH₂(CH₂)₁₀CH₃), 48.8 (NCH₃), 64.0 (OCH₂(CH₂)₁₀CH₃), 64.5 (NCH₂(CH₂)₂CH₃), 64.9 (NCH₂(CH₂)₂CH₂N), 164.5 (COO(CH₂)₁₁CH₃), 168.6 (COO⁻).

IR: \tilde{v}/cm⁻¹=2957 (w), 2920 (m), 2852 (m), 1714 (m), 1625 (s), 1468 (w), 1400 (w), 1371 (w), 1307 (w), 1170 (s), 1061 (w), 1002 (w), 963 (w), 934 (w), 756 (m), 720 (w), 456 (w).

Elemental analyses: C₂₃H₄₅NO₄ (399.61 g/mol) calculated: C, 69.13%; H, 11.35%; N, 3.51%. found: C, 68.88%; H, 11.75%; N, 3.55%.

### Example 11

### N-Dodecyl-N′-methylimidazolium-dodecyloxalate

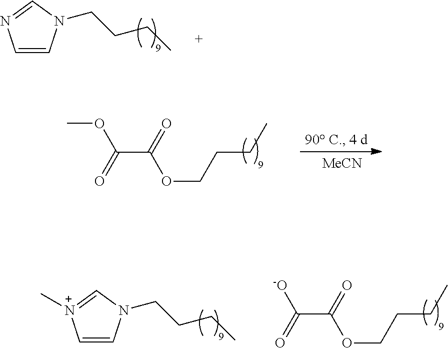

N-Dodecylpyrrolidine (0.35 g, 1.47 mmol) and dodecylmethyloxalate (0.37 g, 1.35 mmol) were stirred in 2 mL acetonitril at 90° C. for four days, washed with hexanes and dried in vacuo. 0.50 g (72%) of a colorless solid were obtained. The melting point is below 100° C.

¹H-NMR (300 MHz, MeCN-d³): δ/ppm=0.88 (t, 6H, ³J_{HH}=6.6 Hz, (CH₂)₁₁CH₃), 1.22-1.37 (m, 36H, (CH₂)₂(CH₂)₉CH₃), 1.55-1.66 (m, 2H, OCH₂CH₂), 1.75-1.86 (m, 2H, NCH₂CH₂), 3.84 (s, 3H, NCH₃), 3.99 (t, 2H, ³J_{HH}=6.8 Hz, OCH₂), 4.13 (t, 2H, ³J_{HH}=7.3 Hz, NCH₂), 7.35-7.41 (m, 2H, NCHCHN), 8.95 (s, 1H, NCHN).

¹³C-NMR (75 MHz, MeCN-d³): δ/ppm=14.4 ((CH₂)₁₁CH₃), 23.4, 26.7, 26.8, 29.6, 29.7, 30.1, 30.1, 30.3, 30.3, 30.4, 30.4, 30.7, 32.7 (CH₂(CH₂)₁₀CH₃), 36.7 (NCH₂(CH₂)₁₀CH₃, 50.4 (NCH₃), 64.0 (OCH₂(CH₂)₁₀CH₃), 123.2 (CH₃NCH₂CH₂), 124.5 (CH₃NCH₂CH₂), 138.1 (NCHN), 164.7 (COO(CH₂)₁₁CH₃), 168.9 (COO⁻).

IR: \tilde{v}/cm⁻¹=3064 (w), 2954 (w), 2918 (s), 2849 (m), 1771 (w), 1746 (w), 1705 (m), 1626 (s), 1559 (w), 1506 (w), 1465 (w), 1396 (w), 1373 (w), 1315 (w), 1285 (w), 1228 (w), 1179 (s), 1165 (s), 1108 (w), 1076 (w), 1015 (w), 986 (w), 961 (w), 905 (w), 878 (w), 815 (w), 794 (w), 767 (w), 749 (w), 723 (w), 661 (w), 631 (w), 530 (w), 471 (w).

Elemental analyses: C₃₀H₅₆N₂O₄ (508.78 g/mol) calculated: C, 70.82%; H, 11.09%; N, 5.51%. found: C, 68.15%; H, 10.85%; N, 5.60%.

### Example 12

### N,N′-Dimethylimidazolium-tert-butyloxalate

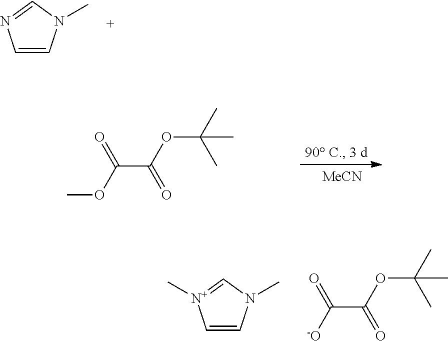

Tert-butylmethyloxalate (0.42 g, 2.63 mmol) and N-methylimidazole (2.07 g, 25.21 mmol) were stirred in 2 mL Acetonitril for three days at 90° C., washed with hexanes and dried in vacuo. 0.59 g (92%) of a brown oil were obtained.

¹H-NMR (300 MHz, MeCN-d³): δ/ppm=1.42 (s, 9H, C(CH₃)), 3.86 (s, 6H, NCH₃), 7.43 (s, 2H, N(CH)₂N), 9.49 (s, 1H, NCHN).

¹³C-NMR (75 MHz, MeCN-d³): δ/ppm=28.4 (C(CH₃)₃), 36.6 (NCH₃), 80.2 (C(CH₃)₃), 124.4 (N(CH)₂N), 139.2 (NCHN), 165.4 (COOC(CH₃)₃), 168.2 (COO⁻).

IR: \tilde{v}/cm⁻¹=2977 (w), 1708 (m), 1618 (s), 1573 (m), 1458 (w), 1391 (w), 1364 (m), 1219 (m), 1145 (s), 895 (w), 861 (w), 775 (s), 715 (w), 623 (m), 475 (w), 420 (w).

Elemental analyses: C₁₁H₁₈N₂O₄ (242.27 g/mol) calculated: C, 54.53%; H, 7.49%; N, 11.56%. found: C, 52.88%; H, 7.43%; N, 11.71%.

### B) Dissolution of Rare Earth Chloride Hydrates

### Example 13

### Dissolution of NdCl₃.6H₂O in N,N′-dimethylimidazolium-methyloxalate

0.15 g (0.40 mmol) of NdCl₃.6H₂O were completely dissolved in 1.39 g (6.96 mmol) of N,N′-dimethylimidazolium-methyloxalate (“IL”) by stirring the mixture for 7 days at room temperature (about 20° C.).

The molar ratio of IL:NdCl₃.6H₂O=17:1

### Example 13a

### Dissolution of NdCl₃.6H₂O in N,N′-dimethylimidazolium-methyloxalate

4.15 g (11.6 mmol) of NdCl₃.6H₂O were stirred in 20.34 g (0.10 mol) of N,N′-dimethylimidazolium-methyloxalate (“IL”) for three days at room temperature (about 20° C.). After this time, the liquid phase was isolated by centrifugation at 4000 rpm and analyzed by ICP-MS. The Nd content in the IL phase was 0.43 g/100 g. This is equivalent to 5% of neodymium dissolved in the IL phase.

The molar ratio of IL:NdCl₃.6H₂O=8.6:1

### Example 14

### Dissolution of SmCl₃.6H₂O in N,N′-dimethylimidazolium-methyloxalate

0.24 g (0.67 mmol) of SmCl₃.6H₂O were completely dissolved in 1.68 g (8.39 mmol) of N,N′-dimethylimidazolium-methyloxalate (“IL”) by stirring the mixture for 5 days at room temperature (about 20° C.).

The molar ratio of IL:SmCl₃.6H₂O=12.5:1

### Example 14a

### Dissolution of SmCl₃.6H₂O in N,N′-dimethylimidazolium-methyloxalate

4.32 g (12.0 mmol) of SmCl₃.6H₂O were stirred in 20.23 g (0.10 mol) of N,N′-dimethylimidazolium-methyloxalate (“IL”) for three days at room temperature (about 20° C.). After this time, the liquid phase was isolated by centrifugation at 4000 rpm and analyzed by ICP-MS. The Sm content in the IL phase was 6.5 g/100 g. This is equivalent to 72% of samarium dissolved in the IL phase.

The molar ratio of IL:SmCl₃.6H₂O=8.33:1

### Example 15

### Dissolution of LaCl₃.7H₂O in N,N′-dimethylimidazolium-methyloxalate

4.06 g (10.9 mmol) of LaCl₃.7H₂O were stirred in 20.10 g (0.10 mol) of N,N′-dimethylimidazolium-methyloxalate (“IL”) for three days at room temperature (about 20° C.). After this time, the liquid phase was isolated by centrifugation at 4000 rpm and analyzed by ICP-MS. The La content in the IL phase was 0.35 g/100 g. This is equivalent to 4% of lanthanum dissolved in the IL phase.

The molar ration of IL:LaCl₃.7H₂O=9.2:1

The above experiments indicate that the IL can discriminate rare earth chlorides at least exemplified here by the different solubility of samariumtrichloride versus the trichlorides of lanthanum or neodymium.

### Example 16

### Recovery of Sm Salt from IL Solution

0.126 g (0.35 mmol) of SmCl₃.6H₂O were stirred in 10.13 g (50.6 mmol) of N,N′-dimethylimidazolium-methyloxalate (“IL”) for 5 hours at room temperature (about 20° C.). Solid material was removed by centrifugation at 4000 rpm. The Sm content of the solution was 0.43 g/100 g, as confirmed by ICP-MS analysis. This is equivalent to 83.8% of Sm dissolved in the IL phase. 4 mL of 1 M hydrochloric acid was added to the mixture, and a colorless solid precipitated. The supernatant was isolated by centrifugation. The Sm content of the solution was <0.01 g/100 g.

### Example 17

### Size Selective Two Phase Liquid Extraction of a Mixture of Six Rare Earth Metal Chlorides by Tributyl-methylphosphonium-2-ethyl-hexyloxalat

2.070 g of an aqueous solution containing Lanthanum-, Cer-, Neodym-, Samarium-, Europium- and Ytterbiumtrichloride (in total 0.101 mmol, the quantitative composition is shown in the lower part of the following table) were stirred together with 3.612 g of an solution of 1.974 g (4.716 mmol) Tributyl-methylphosphonium-2-ethyl-hexyloxalate in 9.433 g dichlormethane for a duration of 20 minutes at room temperature. The phases were separated after a waiting time of 5 minutes. The aqueous phase was analyzed by the method ICP-MS. The results of the ICP-MS analysis is shown in the upper part of the following table. The column “extraction” means x % of the rare earth metal amount present in the aqueous solution have been extracted into the dichlormethane phase.

It can be seen that heavier, smaller rare earth metal cations were better extracted than big ones

| | | Metal amount | | |
|---|---|---|---|---|
| | | in sample | | |
| | metal | g | mmol | extraction % |
| aqueous | La | 2.1082 | 0.0152 | 13.35 |
| solution | Ce | 1.8155 | 0.0130 | 23.53 |
| after | Nd | 1.5015 | 0.0104 | 37.85 |
| extraction | Sm | 1.2778 | 0.0085 | 47.09 |
| | Eu | 1.3968 | 0.0092 | 43.44 |
| | Yb | 1.0898 | 0.0063 | 64.01 |
| aqueous | La | 2.4330 | 0.0175 | — |
| solution | Ce | 2.3741 | 0.0169 | — |
| prior to | Nd | 2.4159 | 0.0167 | — |
| extraction | Sm | 2.4149 | 0.0161 | — |
| | Eu | 2.4693 | 0.0162 | — |
| | Yb | 3.0279 | 0.0175 | — |

1.-11. (canceled)

12. A monosubstituted oxalic acid derivative of the formula (I)
[A]⁺O—C(O)—C(O)—O—X⁻ (I)
Wherein
[A]⁺ is a cation made from an organic moiety A having a formally positively charged heteroatom selected from the group consisting of nitrogen, phosphorus and sulfur
X is a C₁ to C₃₀ organic residue
and wherein the following compounds (I) are disclaimed:
Tetramethylammonium monomethyloxalate
Methyltri(alkyl)ammonium monomethyloxalate
Trimethyl(1-hydroxyethyl)ammonium monomethyloxalate
Methyltriethylammonium monomethyloxalate
Tetraethylammonium monomethyloxalate
n-Propyltriethylammonium mono-n-propyloxalate
n-Butyltriethylammonium mono-n-butyloxalate
Benzyltriethylammonium monobenzyloxalate
cyclohexyldimethylammonium monomethyloxalate
Dimethyl-phenylammonium monomethyloxalate
Tetrabutylammonium monomethyloxalate
N-methylpyridinium monomethyloxalate
N-ethylpyridinium monoethyloxalate
N-n-propylpyridinium mono-n-propyloxalate
N-n-butylpyridinium mono-n-butyl-oxalate
N-benzylpyridinium monobenzyloxalate
N-methyl-isochinolinium monomethyloxalate
N-ethyl-isochinolinium monoethyloxalate
N-n-propyl-isochinolinium mono-n-propyloxalate
N-n-butyl-isochinolinium mono-n-butyloxalate
N-benzyl-isochinolinium monobenzyloxalate.

13. The monosubstituted oxalic acid derivative as claimed in claim 12, wherein [A]⁺ is selected from amongst the compounds of the formulae (IV.e), (IV.s), (IV.v) and (IV.y) 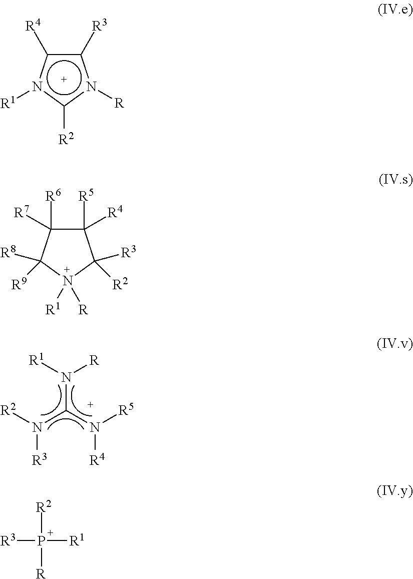
wherein the substituents have the following meaning for the formulae:
R in any case is a C₁ to C₃₀ organic residue
for imidazolium ions (IV.e)
R¹ is hydrogen, methyl, ethyl, 1-propyl, 1-butyl, 1-pentyl, 1-hexyl, 1-octyl, dodecyl, 2-hydroxyethyl or 2-cyanoethyl and R² to R⁴ are each, independently of one another, hydrogen, methyl or ethyl;
for pyrrolidinium ions (IV.s)
R¹ is hydrogen, methyl, ethyl, butyl or phenyl and R² to R⁹ are each, independently of one another, hydrogen or methyl;
for guanidinium ions (IV.v)
R¹ to R⁵ are independently of one another methyl, ethyl or butyl;
for phosphonium ions (IV.y)
R¹ to R³ are each, independently of one another, C₁-C₁₈-alkyl.

14. The monosubstituted oxalic acid derivative as claimed in claim 13, wherein X is selected from the group consisting of unsubstituted straight chain or branched C₁ to C₃₀ alkyl residues.

15. The monosubstituted oxalic acid derivative as claimed in claim 12, wherein the monosubstituted oxalic acid derivative is in the state of an ionic liquid.

16. A process for the preparation of the monosubstituted oxalic acid derivative as claimed in claim 12 wherein the non-quaternized precursor of the organic moiety A is reacted with an oxalic acid compound of the general formula (II)
R¹O—C(O)—C(O)—O—X (II)
wherein R¹ and X are the same or different and are a C₁ to C₃₀ organic residue.

17. A method for at least partially dissolving an inorganic or an organic material comprising utilizing the monosubstituted oxalic acid derivative as claimed in claim 12.

18. The method as claimed in claim 17, wherein the inorganic or organic material is a metal compound.

19. The method as claimed in claim 18, wherein the metal is a rare earth element or an actinide element.

20. A method for separating comprising utilizing the monosubstituted oxalic acid derivative as claimed in claim 12 in a separation process for metals.

21. The method as claimed in claim 20, wherein the metals are rare earth elements and actinide elements.

22. The method as claimed in claim 20 wherein the separation process is a liquid-liquid extraction.
